(19) United States
(12) Patent Application Publication
(10) Pub. No.: US 2004/0176234 A1
(43) Pub. Date: Sep. 9, 2004

(54) Method for improving separation operation of centrifuges and associated improved separation designs

(75) Inventor: Woon-Fong Leung, Sherbon, MA (US)

Correspondence Address: R. Neil Sudol, 714 Colorado Avenue, Bridgeport, CT, 06605-1601, US

(73) Assignee: BAKER HUGHES INCORPORATED, Houston, TX

(21) Appl. No.: 10/383,283

(22) Filed: Mar. 7, 2003

(51) Int. Cl. B04B 1/20

(52) U.S. Cl. 494/37; 494/53

(57) ABSTRACT

In a method for improving separation performance of a decanter centrifuge, the centrifuge is inspected to determine whether the centrifuge is operating in a Coriolis-resist or a Coriolis-neutral mode wherein Coriolis forces acting on liquid flow tend to direct the liquid flow radially inwardly or axially, respectively. Upon determining that the centrifuge is operating in a Coriolis-resist or Coriolis-neutral mode, the centrifuge is modified to operate in a Coriolis-assist mode where Coriolis forces act on liquid flow in a radially outward direction and thereby augment the action of centrifugal force in the separations process. Radially extending flow obstructions in a ribbon-type centrifuge are provided with radial vanes to compensate for Coriolis forces and improve centrifuge performance.

### FIELD OF THE INVENTION

This invention pertains to decanter-type centrifuges such as ribbon-conveyor centrifuges and decanter-type solid-bowl and screen-bowl centrifuges that have a clarifier section holding a separation pool and a conical beach section. More particularly, this invention relates to a method for improving the sedimentation and separation performance of such centrifuges. In addition, this invention involves associated centrifuge structures and operating modes.

### BACKGROUND OF THE INVENTION

Solid-bowl decanters use centrifugal gravity for the separation of a heavier phase from a light suspension phase, which for now is more conveniently referred to as the solid/particles and liquid, respectively. Screen-bowl centrifuges are typically used for dewatering of the separated heavier phase, which is referred hereafter as cake or sediment.

Most decanter type centrifuges have a cylindrically shaped clarifier but there are some designs with a conical-bowl clarifier, which is integral with a conical beach. In any case, decanter centrifuges have a small diameter end, which for most cases is used for discharging cake and a large diameter end used for either effluent liquid discharge or for feeding.

In a ribbon-conveyor centrifuge, a ribbon blade conveyor is used in the cylindrical clarifier. The thickness of the ribbon blade is just enough to convey cake along an inner surface of the bowl toward a conical beach while allowing effluent liquid to flow axially toward the effluent weir, the pool being much deeper than the thickness of the ribbon. The ribbon may be supported from a conveyor hub by stiff posts or by a set of axial vanes uniformly spaced around the hub and running the entire length of the clarifier section. In both cases, the liquid flows axially from the feed to the overflow weirs.

### Definitions

The following provide some definitions useful for subsequent discussion:

The term “right-hand pitch” is used herein to designate a conveyor scroll direction as illustrated in FIG. 1, machine 1A. The term “left hand pitch” is used herein to designate a conveyor scroll direction as illustrated in FIG. 1, machine 1D.

The term “cocurrent flow” refers herein to an operating mode of decanter centrifuges wherein liquid or suspension/slurry flow is in the same direction as cake transport by a scroll conveyor. The term “countercurrent flow” refers herein to an operating mode of decanter centrifuges wherein liquid or suspension/slurry flow is in a direction opposite to cake transport by a scroll conveyor.

The words “clockwise” (abbreviated CW) and “counterclockwise” (abbreviated CCW) denote herein the direction of rotation of bowl and conveyor as viewed from the large end of the machine (opposite a cake discharge end). A conveyor can rotate faster or slower than bowl in the same rotation direction as the bowl.

The word “junction” is used herein to refer to the intersection between a conical beach and a cylindrical clarifier section of a decanter bowl. The term “junction feed” denotes herein the introduction of the feed in the proximity of the junction. When a conical clarifier bowl section is used instead of the more common cylindrical clarifier bowl section, the clarifier and beach both have a conical profile and the word “junction” then refers to a transition area between two functional regions, namely, a clarification zone and a dewatering zone, which could very well correspond to a single physical geometry. Mid-feed refers to introducing the feed within the interior range (25%-75%) of the clarifier length.

The term “solid blade” refers herein to conveyor blades that not only convey cake but also form helical channels or passages between adjacent blades for flow of suspension and liquid.

The term “ribbon blade” refers herein to conveyor blades taking the form of thin helical ribbons adjacent to the bowl wall for cake conveyance only, the slurry or liquid flowing over the helical ribbon along the axis of the bowl from a feed introduction point to an effluent discharge.

The term “liquid flow” is used to denote flow of a suspension/slurry or clarified liquid.

The letter or abbreviation “G” refers to a centrifugal force, due to centrifuge rotation, which is many times that of earth's gravity.

There are different decanter design permutations pertaining to different combinations of right-hand and left-hand pitch; cocurrent and countercurrent flow; clockwise and counterclockwise rotation; relative rotation speeds of the conveyor and bowl; and locations for feed introduction and clarified effluent discharge. These permutations are termed “operating modes” herein.

### Components Determining Operating Mode

The differential rotation of the conveyor and the bowl is maintained by a gear box which has typically more than one stage for the appropriate gear ratio. A two-stage gear box for some designs allows the conveyor to rotate slower than bowl, whereas other designs allow the conveyor to rotate faster. Also it is known that a hydraulic motor, mechanism, and pump are used to maintain a differential speed between the conveyor and bowl for decanter type centrifuges. Some hydraulic units allow the hydraulic motor to rotate in one direction in which the conveyor rotates faster than bowl while by reversing the rotation direction of the hydraulic motor and mechanism, the conveyor rotates slower than bowl. Obviously, another possibility is to independently drive the conveyor and bowl with separate drives in which the conveyor and bowl rotation direction and relative angular velocity can be easily controlled.

In a decanter type centrifuge, feed slurry is introduced to the feed compartment (not shown) where feed is accelerated to tangential speed before introduction thereof to the separation pool in the clarifier. Heavier solids drop out to the bowl wall to form a compacted cake, which subsequently is conveyed by the scroll conveyor toward the conical beach for discharge. The cake is lifted above the liquid pool in the dry beach where liquid is further drained before discharge. In a screen-bowl centrifuge, cake is presented to a cylindrical screen section for cake washing and dewatering. The cylindrical screen has the same diameter as the conical beach discharge diameter. In the bowl of a decanter centrifuge, the liquid flows along a helix in solid-blade conveyors, or along an axial path in ribbon-blade conveyors, from the feed location to the effluent discharge. Any fine unsettled solids in suspensions drop out under centrifugal force.

For a countercurrent flow design, liquid flow and cake transport are in opposite directions (countercurrent), feed is typically introduced at the junction of the machine with clarified liquid or effluent removed via overflow at weirs located at the large diameter end of the machine. For a cocurrent flow design, feed is introduced at the large end of the machine, and liquid flow and cake transport are in the same direction, toward the conical beach. The effluent liquid is skimmed out at near the junction of the conical beach and the cylinder by a set of tubes returning the liquid back to the large end of the machine for discharge. The cake is conveyed to the conical beach for dewatering prior to discharge.

It is well known to install a circular disk (“floater's weir”) so as to dip into a clarifier pool of a countercurrent flow solid-blade conveyor for trapping floatable solids near the pool surface, thereby preventing the solids from exiting the machine with the liquid effluent. The trapped solids eventually settle to the bowl wall. The floater's weir is used for relative coarse separation such as polyvinyl chloride where occasionally there are porous particles trapping air rendering them buoyant in the liquid pool.

### SUMMARY OF THE INVENTION

The invention pertains to improving separation performance of both solid-blade conveyor and ribbon-blade conveyor designs. For solid-blade design, the new technology can be used in retrofitting existing decanter type machines. However, a limited version can also be used for new equipment design. For ribbon-blade design, the new technology can be applied in both new and retrofit applications.

The present invention is directed in part to a method for improving separation performance of a decanter centrifuge wherein liquid flow is in a first direction and solids transport is in a second direction and wherein rotation of the centrifuge generates a radially outward centrifugal force inducing sedimentation of solids out of the liquid flow. The method comprises inspecting the centrifuge to determine whether the centrifuge is operating in a Coriolis-resist or a Coriolis-neutral mode. If a centrifuge is operating in a Coriolis resist mode, Coriolis forces acting on liquid flow tend to direct the liquid flow radially inwardly, which opposes the centrifugal force and thus reduces the effectiveness of the separations process. If a centrifuge is operating in a Coriolis neutral mode, Coriolis forces acting on liquid flow are directed only perpendicularly to the centrifugal forces and thus have no effect on the separations process. Upon determining that the centrifuge is operating in a Coriolis-resist or Coriolis-neutral mode, the centrifuge is modified to operate in a Coriolis-assist mode where Coriolis forces act on liquid flow in a radially outward direction and thereby augment the action of centrifugal force in the separations process.

Also, when a machine is operating in Coriolis-resist mode, the liquid flow stays at the pool surface due to the Coriolis force directing the liquid radially inward. The flow stays near the pool surface from the feed zone to the effluent discharge. Given the pool surface is at a lower G-force than the pool depths, the separation is not as effective. In contrast, in a machine operating in Coriolis-assist mode, the Coriolis force directs the liquid toward the bowl wall converting the liquid flow into a plug-flow distributed across the entire pool depth. Given that the liquid flow stays at a larger diameter beyond the pool surface, it takes advantage of the higher G-force for separation as the G-force increases with radius.

Another benefit to operating in Coriolis-assist mode as opposed to Coriolis resist mode involves retention time. In a machine operating in Coriolis-resist mode with liquid flow staying near the pool surface, there is a shorter retention time of the liquid flow for the suspended solids to separate, that is, there is a short-circuiting of the pool. In contrast, in a machine operating in Coriolis-assist mode the resultant plug flow allows better utilization of the pool with longer retention time for separation.

Yet another benefit to operating in Coriolis-assist mode as opposed to Coriolis resist mode is that given the plug flow as a result of Coriolis-assist, suspended solids are more distributed across the pool depth with a shorter distance to the bowl wall and accordingly have a shorter distance for separation than in the case of Coriolis-resist mode where liquid and solids stay near the pool surface with a longer distance to travel to the bowl wall.

The centrifuge generally includes a bowl and a conveyor with a differential rotation relative to one another, where the conveyor has a conveyor flight pitch with a given handedness and where the bowl has a selected liquid feed location. The centrifuge is modified to change the direction of rotation of the conveyor and the bowl, the differential rotation of the bowl and the conveyor, the handedness of the conveyor flight pitch, and/or the location of the liquid feed.

Pursuant to the present invention, the modified centrifuge has one of four operating modes, all Coriolis assist operating modes in which the Coriolis force exerted on both the liquid flow and suspended solid particles has a component directed radially outwardly, in parallel to the centrifugal force. In the first mode, the conveyor has a right hand pitch, liquid flow and solids transport are countercurrent to one another, and the conveyor and the bowl rotate counterclockwise as viewed from large end of bowl, with the conveyor rotating faster than bowl. In the second mode, the conveyor has a left hand pitch, liquid flow and solids transport are countercurrent to one another, and the conveyor and the bowl rotate clockwise as viewed from large end of bowl, with the conveyor rotating faster than the bowl. In the third mode, the conveyor has a right hand pitch, liquid flow and solids transport are cocurrent with one another, and the conveyor and the bowl rotate clockwise as viewed from large end of bowl, with the bowl rotating faster than the conveyor. In the fourth mode, the conveyor has a left hand pitch, liquid flow and solids transport are cocurrent with one another, and the conveyor and the bowl rotate counterclockwise as viewed from large end of bowl, with the bowl rotating faster than the conveyor. Countercurrent flow machines have a liquid feed located at or about the junction of the beach and the clarifier pool section of the bowl and an effluent discharge located at the large end of the bowl opposite the beach. Cocurrent flow machines have an effluent discharge located at or about the junction of the beach and the clarifier pool section of the bowl and a liquid feed located at the large end of the bowl opposite the beach.

The inspection of the centrifuge may reveal that (a) the conveyor has a right hand pitch, (b) the centrifuge has a liquid feed at a junction between a beach section of the bowl and a clarifier pool section of the bowl, (c) the centrifuge has an effluent discharge at a large end of the bowl, opposite the beach section, so that liquid flow and solids transport are countercurrent to one another, and (d) the bowl and the conveyor rotate in a clockwise direction as viewed from the large end of the bowl, with the bowl rotating faster than the conveyor. In that case, the centrifuge may be modified to change the direction of rotation of the conveyor and the bowl from clockwise to counterclockwise as viewed from the large end of the bowl. In addition, the differential rotation of the bowl and the conveyor is changed so that the conveyor rotates faster than the bowl. Alternatively, the modifying of the centrifuge may include changing the conveyor to have a left-hand pitch. The modifying of the centrifuge then further includes changing the differential rotation of the bowl and the conveyor so that the conveyor rotates faster than the bowl.

The inspection of the centrifuge may reveal that (a) the conveyor has a left hand pitch, (b) the centrifuge has a liquid feed at a junction between a beach section of the bowl and a clarifier pool section of the bowl, (c) the centrifuge has an effluent discharge at a large end of the bowl, opposite the beach section, so that liquid flow and solids transport are countercurrent to one another, and (d) the bowl and the conveyor rotate in a counterclockwise direction as viewed from the large end of the bowl, with the bowl rotating faster than the conveyor. In that case, the centrifuge may be modified to change the direction of rotation of the conveyor and the bowl from counterclockwise to clockwise as viewed from the large end of the bowl. In addition, the differential rotation of the bowl and the conveyor is changed so that the conveyor rotates faster than the bowl. Alternatively, the modifying of the centrifuge may include changing the conveyor to have a right hand pitch. Then the modifying of the centrifuge further includes changing the differential rotation of the bowl and the conveyor so that the conveyor rotates faster than the bowl.

The inspection of the centrifuge may reveal that (i) the conveyor has a right hand pitch, (ii) the centrifuge has a liquid feed within a middle range of a clarifier pool section of the bowl, (iii) the centrifuge has an effluent discharge at a large end of the bowl, opposite a beach section, so that liquid flow and solids transport are countercurrent to one another, and (iv) the bowl and the conveyor rotate in a counterclockwise direction as viewed from the large end of the bowl, with the conveyor rotating faster than the bowl. The centrifuge may then be modified to alter the conveyor to have a left hand pitch while the direction of rotation of the conveyor and the bowl is changed from counterclockwise to clockwise as viewed from the large end of the bowl. The liquid feed introduction is relocated to the proximity of the junction or even further up the conical beach to maximize the clarification length and volume.

The inspection of the centrifuge may reveal that (A) the conveyor has a left hand pitch, (B) the centrifuge has a liquid feed within a middle range of a clarifier pool section of the bowl, (C) the centrifuge has an effluent discharge at a large end of the bowl, opposite a beach section, so that liquid flow and solids transport are countercurrent to one another, and (D) the bowl and the conveyor rotate in a clockwise direction as viewed from the large end of the bowl, with the conveyor rotating faster than the bowl. In that case, the centrifuge may be modified by altering the conveyor to have a right hand pitch while changing the direction of rotation of the conveyor and the bowl from clockwise to counterclockwise as viewed from the large end of the bowl. The liquid feed introduction is relocated to the proximity of the junction or even further up the conical beach to maximize the clarification length and volume.

The inspection of the centrifuge may reveal that (1) the conveyor has a right hand pitch, (2) the centrifuge has an effluent discharge at a junction between a beach section of the bowl and a clarifier pool section of the bowl, (3) the centrifuge has a liquid feed at a large end of the bowl, opposite the beach section, so that liquid flow and solids transport are cocurrent to one another, and (4) the bowl and the conveyor rotate in a counterclockwise direction as viewed from the large end of the bowl, with the conveyor rotating faster than the bowl. In that event, the modifying of the centrifuge may include changing the direction of rotation of the conveyor and the bowl from counterclockwise to clockwise as viewed from the large end of the bowl. The modifying of the centrifuge may further include changing the differential rotation of the bowl and the conveyor so that the bowl rotates faster than the conveyor. Alternatively, the modifying of the centrifuge in this case includes changing the conveyor to have a left hand pitch. Following this alternative, the differential rotation of the bowl and the conveyor are also changed so that the bowl rotates faster than the conveyor.

The inspection of the centrifuge may reveal that (a) the conveyor has a left hand pitch, (b) the centrifuge has an effluent discharge at a junction between a beach section of the bowl and a clarifier pool section of the bowl, (c) the centrifuge has a liquid feed at a large end of the bowl, opposite the beach section, so that liquid flow and solids transport are cocurrent to one another, and (d) the bowl and the conveyor rotate in a clockwise direction as viewed from the large end of the bowl, with the conveyor rotating faster than the bowl. The modifying of the centrifuge may be accomplished by changing the direction of rotation of the conveyor and the bowl from clockwise to counterclockwise as viewed from the large end of the bowl. An additional modification in this case is to change the differential rotation of the bowl and the conveyor so that the bowl rotates faster than the conveyor. Alternatively, the modifying of the centrifuge in this case may include changing the conveyor to have a right hand pitch and changing the differential rotation of the bowl and the conveyor so that the bowl rotates faster than the conveyor.

The inspection of the centrifuge may reveal that (a) the conveyor has a right hand pitch, (b) the centrifuge has a liquid feed within a middle range of a clarifier pool section of the bowl, (c) the centrifuge has an effluent discharge at a junction between a beach section of the bowl and a clarifer pool section of the bowl, so that liquid flow and solids transport are cocurrent to one another, and (d) the bowl and the conveyor rotate in a clockwise direction as viewed from the large end of the bowl, with the bowl rotating faster than the conveyor. In this case, the modifying of the centrifuge may include changing the conveyor to have a left hand pitch and changing the direction of rotation of the conveyor and the bowl from clockwise to counterclockwise as viewed from the large end of the bowl.

The inspecting of the centrifuge may reveal that (i) the conveyor has a left hand pitch, (ii) the centrifuge has a liquid feed within a middle range of a clarifier pool section of the bowl, (iii) the centrifuge has an effluent discharge at a junction between a beach section of the bowl and a clarifer pool section of the bowl, so that liquid flow and solids transport are cocurrent to one another, and (iv) the bowl and the conveyor rotate in a counterclockwise direction as viewed from the large end of the bowl, with the bowl rotating faster than the conveyor. In this case, the modifying of the centrifuge includes changing the conveyor to have a right hand pitch and changing the direction of rotation of the conveyor and the bowl from counterclockwise to clockwise as viewed from the large end of the bowl.

The modifying of the centrifuge pursuant to the method of the present invention may include changing the effluent discharge location together with the liquid feed location, thereby altering the flow pattern in the centrifuge either from countercurrent flow to cocurrent flow or from cocurrent flow to countercurrent flow. In particular, where the inspecting of the centrifuge reveals that the conveyor has a right hand pitch, the centrifuge has a liquid feed located at a junction between a beach section of the bowl and a clarifier pool section of the bowl, the centrifuge has an effluent discharge located at a large end of the bowl, opposite the beach section, so that liquid flow and solids transport are countercurrent to one another, and the bowl and the conveyor rotate in a clockwise direction as viewed from the large end of the bowl, with the bowl rotating faster than the conveyor, the modifying of the centrifuge includes changing the location of the liquid feed to the large end of the bowl and changing the location of the effluent discharge to the junction. Alternatively in this case, the modifications may additionally include changing the direction of rotation of the conveyor and the bowl from clockwise to counterclockwise as viewed from the large end of the bowl, and changing the handedness of the conveyor to a left hand pitch.

In another flow pattern conversion pursuant to the method of the present invention, the inspecting of the centrifuge reveals that the conveyor has a left hand pitch, the centrifuge has a liquid feed at a junction between a beach section of the bowl and a clarifier pool section of the bowl, the centrifuge has an effluent discharge at a large end of the bowl, opposite the beach section, so that liquid flow and solids transport are countercurrent to one another, and the bowl and the conveyor rotate in a counterclockwise direction as viewed from the large end of the bowl, with the bowl rotating faster than the conveyor. In this case, the modifying of the centrifuge includes changing the location of the liquid feed to the large end of the bowl and changing the location of the effluent discharge to the junction. Alternatively, the modifications to the centrifuge may additionally include changing the direction of rotation of the conveyor and the bowl from counter clockwise to clockwise as viewed from the large end of the bowl, and changing the handedness of the conveyor to a right hand pitch.

In a further flow pattern conversion pursuant to the method of the present invention, the inspecting of the centrifuge reveals that the conveyor has a right hand pitch, the centrifuge has an effluent discharge located at a junction between a beach section of the bowl and a clarifier pool section of the bowl, the centrifuge has a liquid feed located at a large end of the bowl, opposite the beach section, so that liquid flow and solids transport are cocurrent to one another, and the bowl and the conveyor rotate in a counterclockwise direction as viewed from the large end of the bowl, with the conveyor rotating faster than the bowl. The modifying of the centrifuge then includes changing the location of the liquid feed to the junction and changing the location of the effluent discharge to the large end of the bowl. Optional additional modifications in this case include changing the direction of rotation of the conveyor and the bowl from counterclockwise to clockwise as viewed from the large end of the bowl, and changing the handedness of the conveyor to a left hand pitch.

In yet another flow pattern conversion pursuant to the method of the present invention, the inspecting of the centrifuge reveals that the conveyor has a left hand pitch, the centrifuge has an effluent discharge at a junction between a beach section of the bowl and a clarifier pool section of the bowl, the centrifuge has a liquid feed at a large end of the bowl, opposite the beach section, so that liquid flow and solids transport are cocurrent to one another, and the bowl and the conveyor rotate in a clockwise direction as viewed from the large end of the bowl, with the conveyor rotating faster than the bowl. The modifying of the centrifuge in this case includes changing the location of the liquid feed to the junction and changing the location of the effluent discharge to the large end of the bowl. Optional additional modifications include changing the direction of rotation of the conveyor and the bowl from clockwise to counterclockwise as viewed from the large end of the bowl, and changing the handedness of the conveyor to a right hand pitch.

Pursuant to another feature of the present invention, separation performance of a decanter centrifuge may be additionally improved by attaching to the conveyor, between adjacent flights thereof, at least one baffle extending across a path of liquid flow from a liquid feed to an effluent discharge. The baffle may extend from a hub of the conveyor partially into a clarifier pool. The baffle may be one of a plurality of baffles extending from the hub of the conveyor partially into the clarifier pool and across the path of liquid flow from the liquid feed to the effluent discharge. At least one such baffle is disposed proximately to the liquid feed.

Pursuant to a further feature of the present invention, one or more secondary baffles may be attached to the conveyor, between adjacent flights thereof, extending into the liquid pool across a path between the feed ports and the cake discharge end of the centrifuge. At least one such secondary baffle is disposed proximately to the liquid feed.

Pursuant to the present invention, separation performance of a decanter centrifuge having bowl and a conveyor and a liquid feed in a middle range of a clarifier pool section of the bowl, where the centrifuge is provided with an effluent discharge near one end of the bowl, may be improved by relocating the liquid feed to an end of the bowl opposite the effluent discharge in the proximity of the junction and even further up the conical beach to maximize the length or pool volume for separation.

An embodiment of a decanter centrifuge comprises, in accordance with the present invention, a bowl having a cylindrical clarifier pool section and a conical beach section, a liquid feed at a junction of the clarifier pool section and the beach section, an effluent discharge at a large end of the bowl, opposite the beach section, a conveyor having a right hand pitch, and a drive assembly operatively connected to the conveyor and the bowl for rotating the conveyor and the bowl in a counterclockwise direction as viewed from the large end of the bowl, with the conveyor rotating faster than the bowl.

Another embodiment of a decanter centrifuge in accordance with the present invention comprises a bowl having a cylindrical clarifier pool section and a conical beach section, an effluent discharge at a junction of the clarifier pool section and the beach section, a liquid feed at a large end of the bowl, opposite the beach section, a conveyor having a left hand pitch, and a rotary drive assembly operatively connected to the conveyor and the bowl for rotating the conveyor and the bowl in a counterclockwise direction as viewed from the large end of the bowl, with the bowl rotating faster than the conveyor.

A further embodiment of a decanter centrifuge in accordance with the present invention comprises a bowl having a cylindrical clarifier pool section and a conical beach section, an effluent discharge on the bowl, a liquid feed on the bowl, a conveyor disposed inside the bowl for differential rotation therewith, and at least one baffle attached to the conveyor between adjacent flights thereof and extending across a path of liquid flow from the liquid feed to the effluent discharge. The baffle may extend from a hub of the conveyor partially into a clarifier pool. The baffle may be one of a plurality of baffles extending from the hub of the conveyor partially into the clarifier pool and across the path of liquid flow from the liquid feed to the effluent discharge. At least one of the baffles is disposed proximate to the liquid feed. One or more secondary baffles may be attached to the conveyor, between adjacent flights thereof, extending across a path of cake transport towards a beach section of a bowl of the centrifuge. At least one such secondary baffle is optionally attached to the conveyor proximately to the liquid feed.

Yet another embodiment of a centrifuge in accordance with the present invention comprises a bowl, a ribbon conveyor disposed in the bowl, and at least one flow guide member extending from a hub of the conveyor into a clarifier pool in the bowl for redirecting liquid flow in the clarifier pool in an at least partially radially outward direction

Pursuant to additional features of the present invention, the flow guide member is provided on an upstream side with at least one vane extending into the clarifier pool, preferably in a generally radial direction, the vane(s) having an outer edge disposed at a radial distance from an axis of the bowl less than a radial distance of an outer edge of the flow guide member from the axis. An outer end portion of the vane may be directed at least partially in a rotation forward direction.

Where there are plural vanes on the flow guide member, the vanes are spaced from one another in a circumferential direction of the guide member and extending in a generally radial direction into the clarifier pool.

The flow guide member may take the form of an annular disc, a truncated cone, or a cylinder with an end plate with possible cut-outs and slots on an upstream side. In the case of a cylinder, which may be viewed as a hub extension, the upstream side of the cylinder may be an annular disk, a truncated cone or some other geometry tending to direct fluid flow in a radial outer direction to the cylindrical surface of the flow guide.

Both the baffles and flow guide are effective means to stop surface flow and convert the surface flow to a plug flow for better separation.

### BRIEF DESCRIPTION OF THE DRAWINGS

FIG. 1 is a diagram of six centrifuge conveyors having respective centrifuge operating modes with countercurrent flow of liquid or slurry and cake solids, where arrows between pairs of operating modes represent conversions for improving separation performance in accordance with the present invention.

FIG. 2 is a diagram of six centrifuge conveyors having respective centrifuge operating modes with cocurrent flow of liquid or slurry and cake solids, where arrows between pairs of operating modes indicate conversions for improving separation performance in accordance with the present invention.

FIG. 3 is a vector diagram illustrating the relative magnitudes of axial and radial velocities of a particle in a conventional ribbon-blade centrifuge.

FIG. 4 is a partially an axial cross-sectional view of a centrifuge bowl with a flow obstruction and partially a vector diagram of resulting liquid flow and velocity components of a particle.

FIG. 5A is a schematic partial axial cross-sectional view similar to FIG. 4, showing clarifier pool levels owing to flow resistance arising by virtue of the flow depicted in FIG. 4.

FIG. 5B is a radial or transverse cross-sectional view, taken along line VB-VB in FIG. 5A.

FIG. 6A is a schematic partial axial cross-sectional view similar to FIG. 5A, showing one of several radial vanes on the obstruction of FIG. 5A and a change in clarifier pool levels owing to the vanes.

FIG. 6B is a radial or transverse cross-sectional view, taken along line VIB-VIB in FIG. 6A.

FIG. 6C is a partial radial or transverse cross-sectional view, taken along line VIC-VIC in FIG. 6A, showing fluid flow downstream of the obstruction.

FIG. 7A is a schematic partial axial cross-sectional view of a ribbon centrifuge with flow obstructions in accordance with the present invention.

FIG. 7B is an elevational view of a disk-shaped flow obstruction depicted in FIG. 7A.

FIG. 8A is a schematic partial axial cross-sectional view of another ribbon centrifuge with flow obstructions in accordance with the present invention.

FIG. 8B is an elevational view of a conical flow obstruction depicted in FIG. 8A.

FIG. 9A is a schematic partial axial cross-sectional view of a further ribbon centrifuge with flow obstructions in accordance with the present invention.

FIG. 9B is a an elevational view of a flow obstruction depicted in FIG. 9A.

FIG. 10A is a schematic partial axial cross-sectional view of an additional ribbon centrifuge with flow obstructions in accordance with the present invention.

FIG. 10B is a an elevational view of a flow obstruction depicted in FIG. 10A.

FIG. 11A is a schematic partial axial cross-sectional view of yet another ribbon centrifuge with flow obstructions in accordance with the present invention.

FIG. 11B is a an elevational view of a flow obstruction depicted in FIG. 11A.

FIG. 12 is a schematic partial axial cross-sectional view similar to FIGS. 4 and 5A, showing an obstruction in accordance with the present invention and critical dimensions thereof.

FIG. 13 is a schematic partial transverse cross-sectional view similar to FIGS. 5B and 6B, showing a modification of the obstruction and vanes of FIGS. 6A and 6B.

FIG. 14 is a schematic partial transverse cross-sectional view similar to FIG. 13, showing another modification of the obstruction and vanes of FIGS. 6A and 6B.

FIG. 15 is a schematic partial elevational view of a right-hand-pitch conveyor of a decanter centrifuge, showing flow guide baffles in accordance with the present invention.

FIG. 16 is a schematic partial elevational view of a left-hand-pitch decanter conveyor, showing flow guide baffles in accordance with the present invention.

FIG. 17 is a schematic elevational view of a representative baffle of FIG. 15 or 16.

FIG. 18 is a schematic side elevational view of a centrifuge conveyor, in a vertical orientation, showing baffles for improving separations efficiency, in accordance with the present invention.

FIG. 19 is a vector diagram showing Coriolis forces directing liquid in a centrifuge.

FIG. 20 is a vector diagram showing the Coriolis force and the centrifugal force in a centrifuge operating in a Coriolis assist mode in accordance with the invention.

FIG. 21 is a vector diagram showing the Coriolis force and the centrifugal force in a conventional centrifuge operating in a Coriolis resist mode.

FIG. 22 is a graph showing solids capture as a function of feed rate, in a conventional centrifuge operatiing without Coriolis assist and a centrifuge operating in a Coriolis assist mode in accordance with the present invention.

### DEFINITIONS

The definitions set forth above in the Background section of this disclosure are hereby repeated and incorporated herein. In addition:

The term “Coriolis assist” is used herein to designate a mode of centrifuge operation wherein Coriolis forces acting on liquid flow and on solid particles suspended in the liquid flow have a component directed radially outwardly, thereby augmenting the action of centrifugal force in the separations process. Thus, in a Coriolis-assist operating mode, the Coriolis forces are oriented at least partially radially outwardly.

The term “Coriolis resist” is used herein to designate a mode of centrifuge operation wherein Coriolis forces acting on liquid flow and on solid particles suspended in the liquid flow have a component directed radially inwardly, thereby opposing the action of centrifugal force in the separations process. Thus, in a Coriolis-resist operating mode, the Coriolis forces are oriented at least partially radially inwardly.

The term “Coriolis neutral” is used herein to designate a mode of centrifuge operation wherein Coriolis forces acting on liquid flow and on solid particles suspended in the liquid flow have components directed only perpendicularly to the radial direction, thereby neither augmenting nor opposing the action of centrifugal force in the separations process. Thus, in a Coriolis-neutral operating mode, the Coriolis forces are directed only axially, only tangentially, or only axially and tangentially.

The term “differential rotation” is used herein to indicate that the conveyor and the bowl rotate at different angular speeds (but always in the same direction). By the phrase “changing the differential rotation” is meant that the relative rotation rates of the bowl and the conveyor are changed so that the slower of the two is made to be the faster. The change of differential rotation is usually coupled with a change in the direction of rotation of the bowl and conveyor, a changein the handedness of the pitch, and/or a change in the feed and effluent locations even to the extent that a cocurrent machine is modified to a countercurrent and vice versa.

The words “axial,” “radial,” and “tangential” are all used herein with reference to a rotating machine taken as a whole. Thus, the word “axial” means parallel to the rotation axis of a centrifuge bowl and conveyor, the word “radial” means generally perpendicular to the rotation axis, and the word “tangential” refers to the direction generally perpendicular to both the rotation axis and the radial direction.

The term “rotation forward” is used herein to denote a direction having a tangential component pointed in the direction of rotation of a centrifuge machine.

The word “hub” is used herein to refer to any structure extending along the axis of a rotating machine for supporting parts extending outwardly from that axis. A hub is exemplarily cylindrical, or polygonal or star-shaped in cross-section.

The term “decanter-type centrifuge” is used herein to denote ribbon-conveyor centrifuges and solid-bowl and screen-bowl centrifuges that have a clarifier section holding a separation pool and a conical beach section.

The term “decanter centrifuge” is used herein to denote solid-bowl and screen-bowl centrifuges that have a solid (as opposed to ribbon) conveyor blade and that have a clarifier section holding a separation pool and a conical beach section. The clarifier section can be cylindrical or conical. In the latter case, the conical clarifier is attached to, or merged with, the conical beach section for cake dewatering and discharge while the large diameter is used for effluent discharge in a countercurrent flow design and for feeding in a cocurrent flow design. In either case, dewatering occurs along a conical beach section of the centrifuge bowl, while clarification occurs in the clarifier pool section.

### DETAILED DESCRIPTION OF THE PREFERRED EMBODIMENTS

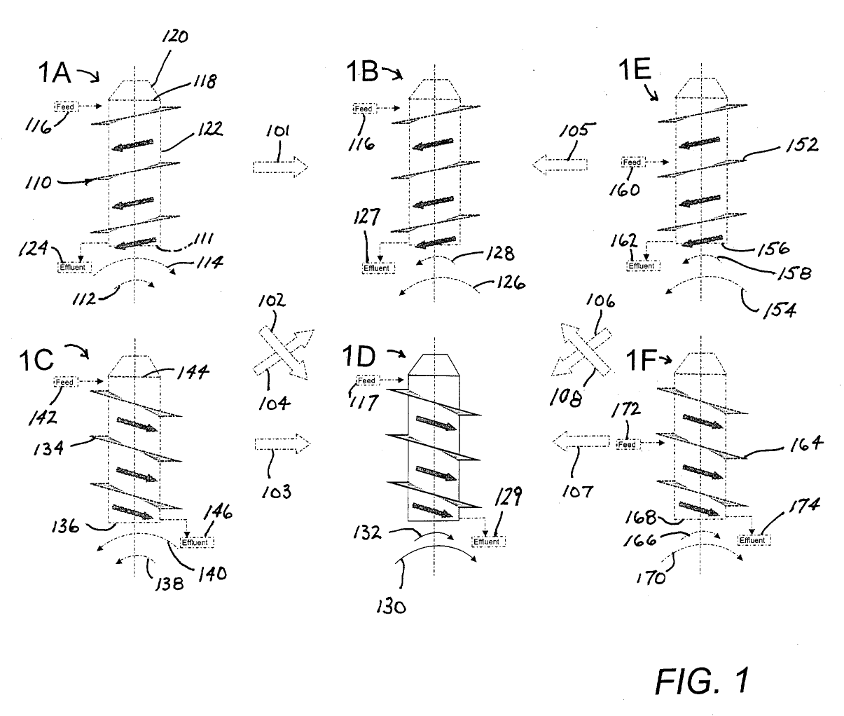

FIG. 1 is a diagram of six different centrifuge operating modes 1A-1F where the centrifuge has a solid-blade conveyor and where flow of the slurry or suspension (“liquid flow”) and transport of deposited sediment or cake (“cake transport”) are in opposing directions, in a countercurrent flow. Arrows 101-108 represent changes made in machine operation for purposes of enhancing separation performance of machines operating at less-than-optimum efficiency. For purposes of clarity, the centrifuge bowl is omitted in the various machine depictions in FIG. 1.

At position 1A in FIG. 1 is shown a decanter machine with a conveyor 110 having a right-hand pitch and rotating clockwise when viewed from a large or effluent end 111 of the machine, as indicated by an arrow 112. The bowl also rotates clockwise, as indicated by an arrow 114. The conveyor 110 is rotating slower than the bowl as represented by the relative lengths of rotational arrows 112 (for conveyor) and 114 (for bowl). A feed input port 116 for introducing a slurry into the bowl is located in the proximity of a junction 118 between a beach section 120 and a clarifier pool section 122 of the centrifuge. An effluent discharge 124 is located at the large end 111 of the machine. Machine operating mode IA is defined by the right-handedness of the conveyor 110, the direction of rotation of the conveyor 110 and the bowl, the faster speed of the bowl, and the countercurrent directions of the liquid or suspension flow and the cake transport. However, this existing machine operating mode 1A can be modified to provide better separation for the same rotation speed (same G-force), same pool depth, same differential speed and same feed rate.

There are two possibilities for conversion of decanter operating mode 1A to one with better separation performance. The first possibility is to reverse the direction of the conveyor 110 and bowl such that both rotate counterclockwise from the large end of the machine. In conjunction, the conveyor 110 rotates faster than the bowl. Thus, machine operating mode 1A may be modified (arrow 101) by changing the direction of rotation of the rotating assembly (bowl and conveyor 110) from clockwise to counterclockwise with the conveyor 110 rotating faster than the bowl, as indicated by rotational arrows 126 (for conveyor) and 128 (for bowl) in machine operating mode 1B. In that operating mode, feed port 116 and cake discharge area have a severe need to be protected with wear-resistant material as the direction of rotation increases erosion in these areas. In addition, it may also prove necessary to modify a bearing lubrication system if the original design of the machine of operating mode 1A is such that oil/grease flows in only one direction.

The second possibility for conversion of an existing operating mode of a decanter centrifuge to one with better separation performance is to convert the existing right-hand pitch to a left-hand pitch with the same pitch arrangement maintaining the same number of leads, pitches, and helices. The conveyor and bowl maintain the same clockwise rotation as viewed from the large end of the machine. However, the conveyor needs to rotate faster compared to the bowl. Thus, machine operating mode 1A may be modified (arrow 102) by changing the relative rotation speeds of the bowl and conveyor 110 so that the conveyor 110 rotates faster than the bowl, as indicated by rotational arrows 130 (for conveyor) and 132 (for bowl) in machine operating mode 1D.

In another known decanter operating mode IC shown FIG. 1, a conveyor 134 has a left-hand pitch and rotates counterclockwise when viewed from a large or effluent end 136 of the machine, as indicated by an arrow 138. The bowl also rotates counterclockwise, as indicated by an arrow 140. The conveyor 134 rotates slower than the bowl as represented by the relative lengths of rotational arrows 138 and 140. A feed input port 142 for introducing a slurry or suspension liquid into the bowl is located in the proximity of a beach-clarifier junction 144. An effluent discharge 146 is located at the large end 136 of the machine. Machine operating mode IC is defined by the left-handedness of the conveyor 134, the counterclockwise rotation of the conveyor 134 and the bowl, the faster speed of the bowl, and the countercurrent directions of the liquid or suspension flow (from port 142 to discharge 146) and the cake transport. This existing machine operating mode 1C can be modified to provide better separation for the same rotation speed (same G-force), same pool depth, same differential speed and same feed rate.

There are two methods for converting decanter operating mode 1C to one with better performance. The first method, represented by arrow 103, is to reverse the direction of the conveyor 134 and the bowl such that both rotate clockwise from the large end of the machine, as indicated by respective rotational arrows 130 and 132 (operating mode 1D). In conjunction, the conveyor 134 rotates faster than the bowl, as indicated by the relative lengths of arrows 130 and 132. By rotating the rotating assembly (bowl and conveyor) in a different direction, the feed port 142 and cake discharge area in which erosion is expected to be most severe need to be protected with wear-resistant material as the direction of rotation affects these areas. As necessary, the bearing lubrication system might need to be modified if the original design is such that oil/grease flows in only one direction.

The second method for converting decanter operating mode 1C to one with better performance is to convert the existing left-hand pitch of conveyor 134 to a right-hand pitch with the same pitch arrangement maintaining the same number of leads, pitches, or helices (arrow 104). The conveyor 134 and bowl maintain the same clockwise rotation as viewed from the large end of the machine. However, the conveyor needs to rotate faster compared to the bowl, as indicated by the relative lengths of rotational arrows 126 and 128.

Decanter operating mode 1E exists in a mid-feed machine with a conveyor 152 having right-hand pitch and rotating counterclockwise (arrow 154) as viewed from the effluent or large end 156 of the machine. The conveyor 152 (rotational arrow 154) rotates faster than the bowl (rotational arrow 158). A feed input port 160 is located in a middle range of the clarifier pool length, while an effluent discharge 162 is at the large end 156 of the machine. This existing machine operating mode 1E can be modified to provide better separation for the same rotation speed (same G-force), same pool depth, same differential speed and same feed rate.

This geometry is highly undesirable because (1) the clarification length measured between the feed port and the effluent discharge is significantly reduced, and (2) if the flow is directed towards the conical beach the flow is in Coriolis resist mode before converting to Coriolis assist mode as the flow turns back from the conical beach towards the effluent discharge.

There are two methods for conversion of the machine operating mode 1E to one with better performance. In the first method, indicated by arrow 105, the feed location is changed from the mid feed 160 to a junction feed as in operating mode 1B. The other operating parameters remain the same. The conveyor 152 and bowl continue to rotate counterclockwise as viewed from the large end of the machine with the conveyor rotating faster than the bowl.

The second method for conversion of the machine operating mode 1E to one with better performance is indicated by arrow 106. Pursuant to this method, the feed location is moved from the mid feed to junction feed and, in addition, the right-hand pitch is converted to a left-hand pitch, while the direction of rotation of both the bowl and conveyor is changed to clockwise as viewed from the large end of the machine, with the conveyor rotating faster (operating mode 1D). As discussed above, several items need attention when the rotation direction is reversed such as wear and lubrication system for the bearings and seals.

In another known decanter operating mode IF, a centrifuge with a conveyor 164 having left-hand pitch and rotating clockwise (arrow 170) as viewed from the large end 168 of the machine. The conveyor 164 rotates faster than the bowl (rotational arrow 166). A feed input port 172 is located in a middle range of the clarifier pool length, while an effluent discharge 174 is at the large end 168 of the machine. This existing machine operating mode 1F can be modified to provide better separation for the same rotation speed (same G-force), same pool depth, same differential speed and same feed rate.

There are two methods for conversion of the machine operating mode 1F to one with better performance. In the first method, indicated by arrow 107, the only change is that the feed location is changed from the mid feed 172 to a junction feed as in operating mode 1D. The conveyor 164 and bowl continue to rotate clockwise as viewed from the large end of the machine with the conveyor rotating faster than the bowl.

The second method for conversion of the machine operating mode 1F to one with better performance is indicated by arrow 108. Pursuant to this method, the feed location is moved from the mid feed to junction feed and, in addition, the left-hand pitch is converted to a right-hand pitch, while the direction of rotation of both the bowl and conveyor is changed to counterclockwise as viewed from the large end of the machine, with the conveyor rotating faster (operating mode 1B). Again, several items need attention when the rotation direction is reversed such as wear and lubrication system for the bearings and seals.

It is to be noted that centrifuge operating mode 1B with right-hand pitch, counterclockwise rotation from the large end of the machine, and with the conveyor rotating faster than the bowl, is a new operating mode and concomitantly a new machine. Solid-liquid separation is enhanced in terms of high throughput at the same effluent quality or better effluent quality at the same throughput can be realized.

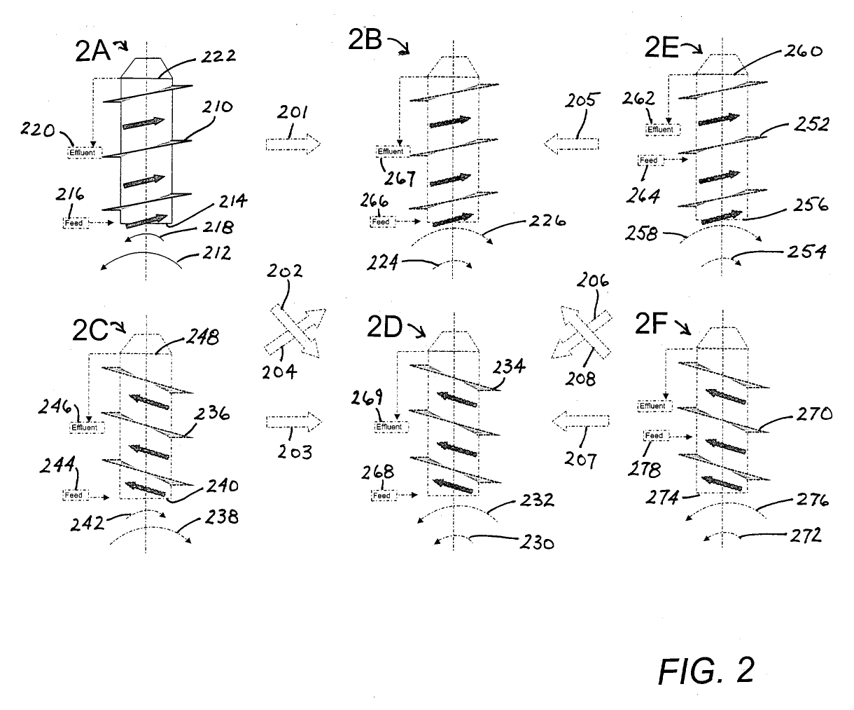

FIG. 2 is a diagram of six different centrifuge operating modes 2A-2F where the centrifuge has a solid-blade conveyor and where flow of the slurry or suspension (“liquid flow”) and transport of deposited sediment or cake (“cake transport”) are in the same direction, in a cocurrent flow. Arrows 201-208 represent methods for changing machine operation for purposes of enhancing separation performance of machines operating at less-than-optimum efficiency. For purposes of clarity, the centrifuge bowl is omitted in the various machine depictions in FIG. 2.

In a decanter operating mode 2A shown in FIG. 2, a conveyor 210 has a right-hand pitch and rotates counterclockwise (rotation arrow 212) as viewed from a large end 214 of the machine where a feed input port 216 is located. The bowl (not shown) also rotates counterclockwise, as indicated by a rotation arrow 218. As represented by the relative lengths or rotation arrows 212 and 218, conveyor 210 has a higher angular speed than the bowl. An effluent discharge 220 is disposed at a beach-clarifier junction 222 of the decanter and is connected to dedicated return pipes (not illustrated) so that the effluent does not mix with the feed slurry in the clarifier pool. Existing machines with operating mode 2A can provide better separation for the same rotation speed (same G-force), same pool depth, same differential speed and same feed rate if the mode of operation is changed.

There are two methods for conversion of a decanter machine operating in mode 2A to one with better separation performance. The first method, indicated by arrow 201, contemplates reversing the direction of the conveyor 210 and bowl such that both rotate clockwise from the large end of the machine, with the conveyor rotating slower than the bowl, as indicated by direction arrows 224 and 226. The result is a decanter operating mode 2B. Because the rotating assembly (bowl and conveyor) is turned in a different direction, the feed port 228 and cake discharge area in which erosion is expected to be most severe need to be protected with wear-resistant material as the direction of rotation affects these areas. As necessary, the bearing lubrication system of the decanter when the operating mode is changed from mode 2A to 2B might need to be modified if the original design is such that oil/grease flows in only one direction.

The second method 202 for conversion of a decanter machine operating in mode 2A to one with better separation performance is to convert the right-hand pitch of conveyor 210 to a left-hand pitch with the same pitch arrangement maintaining the same number of leads, pitches, or helices. As indicated by respective rotation arrows 230 (for conveyor) and 232 (for bowl) at operating mode 2D in FIG. 2, the redesigned conveyor 234 and its associated bowl maintain the same counterclockwise rotation as viewed from the large end of the machine. However, the conveyor 234 rotates slower than the bowl, as indicated by the relative lengths of rotation arrows 230 and 232.

In another known decanter operating mode 2C, a conveyor 236 has a left-hand pitch and rotates in a clockwise direction (rotation arrow 238) as viewed from the large end 240 of the machine. The bowl also rotates in the clockwise direction as indicated by a rotation arrow 242, with the conveyor rotating faster than the bowl as represented by the relative lengths of the rotation arrows 238 and 242. A slurry feed port 244 is located at the large end 240 of the machine while an effluent skimming port 246 is located near a junction 248 of the machine. However, this existing machine can provide better separation for the same rotation speed (same G-force), same pool depth, same differential speed and same feed rate if the mode of operation is changed.

There are two methods 203 and 204 for changing decanter operating mode 2C to one with better performance. The first method 203 contemplates reversing the direction of the conveyor and bowl such that both rotate counterclockwise from the large end of the machine (rotation arrows 230 and 232, operating mode 2D). In conjunction, the conveyor rotates slower than the bowl as indicated by the relative lengths of rotation arrows 230 and 232. By rotating the rotating assembly (bowl and conveyor) in a different direction, the feed port 250 and cake discharge area in which erosion is expected to be most severe need to be protected with wear-resistant material as the direction of rotation affects these areas. As necessary, the bearing lubrication system might need to be modified if the original design (operating mode 2C) is such that oil/grease flows in only one direction.

The second method 204 for conversion of a decanter machine operating in mode 2C to one with better separation performance is to convert the existing left-hand pitch to a right-hand pitch with the same pitch arrangement maintaining the same number of leads, pitches, or helices. The conveyor and bowl maintain the same clockwise rotation (224, 226 in operating mode 2B) as viewed from the large end of the machine. However, the conveyor needs to rotate slower compared to the bowl.

In an operating mode 2E, a mid-feed machine has a conveyor 252 with a right-hand pitch that rotates clockwise (arrow 254) as viewed from a large end 256 of the machine. The bowl also rotates clockwise (arrow 258) at an angular speed higher than that of the conveyor (arrow 254). Effluent escapes at a beach-clarifier junction 260 of the machine through skimming pipes schematically represented at 262. This known machine can provide better separation for the same rotation speed (same G-force), same pool depth, same differential speed and same feed rate if the mode of operation is changed.

There are two methods 205 and 206 for conversion of machine operating mode 2E to one with better separation performance. Pursuant to the first method 205, the feed location is changed from the mid feed 264 (operating mode 2E) to a position 266 at the large end of the machine (operating mode 2B). Otherwise, the direction of the conveyor and bowl such that both rotate clockwise (arrows 224, 226) from the large end of the machine with the conveyor rotating slower than the bowl.

The second method 206 for conversion of machine operating mode 2E to one with better separation performance contemplates converting the right-hand pitch to a left-hand pitch and moving the feed location from the mid feed 264 (operating mode 2E) to a location 268 (operating mode 2D) at the large end of the machine. In addition, the rotation direction of the bowl and conveyor is changed to counterclockwise as viewed from the large end of the machine with the conveyor rotating slower, as indicated by rotation arrows 230, 232. As discussed above, it is necessary to attend to several items when the rotation direction is reversed, such as wear and lubrication system for the bearings and seals.

In an operating mode 2F, a mid-feed machine has a left-hand-pitch conveyor 270 that rotates counterclockwise (arrow 272) as viewed from a large end 274 of the machine. The bowl also rotates counterclockwise (arrow 276), at an angular velocity greater than that of the bowl. This existing machine can provide better separation for the same rotation speed (same G-force), same pool depth, same differential speed and same feed rate if the mode of operation is changed.

There are two methods 207 and 208 for conversion of an existing machine operating in mode 2F to one with better performance. Pursuant to the first method 207, the feed location is moved from the mid feed 278 (operating mode 2F) to position 268 at the large end of the machine (operating mode 2D). The conveyor and bowl continue to rotate counterclockwise from the large end of the machine together with the conveyor rotating slower than the bowl.

The second method 208 for converting the machine of operating mode 2F to operate in a more effective mode contemplates changing the conveyor pitch from left-hand (mode 2F) to right-hand (mode 2B) and changing the feed location from the mid feed 278 to end feed 266. Also, the direction of rotation of both the bowl and conveyor needs to be changed to clockwise as viewed from the large end of the machine with the conveyor rotating slower (rotation arrows 224, 226). Again, wear protection and the lubrication system for the bearings and seals must be taken into account.

Summarizing the above discussion with reference to FIG. 2., it is known to design and operate left-hand pitch machines with only clockwise rotation, and with the conveyor rotating faster than the bowl. The performance of this machine can be improved if it is designed differently. For the left-hand pitch scroll, new machines should be designed and built with counterclockwise rotation, conveyor rotating slower than bowl and with feed introduced at the large diameter end of the machine (operating mode 2D). For the right-hand pitch, new machines should be designed and built with clockwise rotation, conveyor rotating slower than bowl and with feed introduced at the large diameter end of the machine (operating mode 2B). In both cases (2D and 2B), better separation in terms of high throughput at the same effluent quality, or better effluent quality at the same throughput can be realized. These two configurations are the preferred cocurrent designs.

It is to be noted that centrifuge operating mode 2D with left-hand pitch, counterclockwise rotation from the large end of the machine, and with the bowl rotating faster than the conveyor, is a new operating mode and concomitantly a new machine. Solid-liquid separation is enhanced in terms of high throughput at the same effluent quality or better effluent quality at the same throughput can be realized

It is clear from the above discussion of FIGS. 1 and 2 that operating modes 1B, 1D, 2B, and 2D are preferred operating modes: they are all Coriolis-assist modes with inherently superior separation performance. It is to be noted that alternative operating mode modifications for purposes of enhancing separation performance may be undertaken between the countercurrent flow modes of FIG. 1 and the cocurrent modes of FIG. 2. In brief, a centrifuge having a countercurrent-flow operating mode 1A, 1C, 1E or 1F may be modified to operate in cocurrent mode 2B or 2D. Concomitantly, a centrifuge having a cocurrent-flow operating mode 2A, 2C, 2E or 2F may be modified to operate in countercurrent mode 1B or 1D.

Modifying a centrifuge to switch the flow pattern from countercurrent to cocurrent or vice versa involves changing the effluent discharge location together with the liquid feed location. More specifically, in converting a centrifuge from a countercurrent operating mode 1A or 1C to a cocurrent operating mode 2B or 2D, the feed ports are changed from location 116 or 142 at beach-clarifier junction 118 or 144 (FIG. 1) to a location 266 or 268 at the large end of the machine (FIG. 2). In addition, effluent discharge ports are moved from a location 124 or 146 at the large end of the machine to a location 267 or 269 (FIG. 2) at a beach-clarifier junction (not labeled). Analogously, in converting a centrifuge from a cocurrent operating mode 2A or 2C to a countercurrent operating mode 1B or 1D, feed ports are repositioned from a location 216 or 244 (FIG. 2) at the large end of the machine to a location 116 or 117 (FIG. 1) at a beach-clarifier junction (not labeled), while effluent discharges are repositioned from a location 220 or 246 at a beach-clarifier junction 222 or 248 to a location 127 or 129 (FIG. 1) at the large end of the bowl (not labeled).

To modify a centrifuge operating in countercurrent mode 1A to operate in cocurrent mode 2B, one replaces liquid feed ports 116 (FIG. 1) with feed ports 266 (FIG. 2). In addition, effluent discharges 124 are removed, while effluent discharges 267 are inserted. Those are the only changes necessary to change a centrifuge from countercurrent operating mode 1A to cocurrent operating mode 2B. To convert a centrifuge from countercurrent operating mode 1A to cocurrent operating mode 2D, it is additionally necessary to change the direction of rotation of the conveyor and the bowl from clockwise (rotational arrows 112 and 114) to counterclockwise (rotational arrows 230 and 232) as viewed from the large end of the bowl, and to change the handedness of the conveyor to a left hand pitch.

To convert a centrifuge from countercurrent operating mode 1C to cocurrent operating mode 2D, one replaces liquid feed ports 142 (FIG. 1) with feed ports 268 (FIG. 2) and effluent discharges 146 with effluent discharges 269 are inserted. No further changes are necessary to change a centrifuge from countercurrent operating mode 1C to cocurrent operating mode 2D. To convert a centrifuge from countercurrent operating mode 1C to cocurrent operating mode 2B, it is additionally necessary to change the direction of rotation of the conveyor and the bowl from counterclockwise (rotational arrows 138 and 140) to clockwise (rotational arrows 224 and 226) as viewed from the large end of the bowl, and to change the handedness of the conveyor to a right hand pitch.

To modify a centrifuge from countercurrent operating mode 2A to operate in countercurrent mode 1B, one replaces liquid feed ports 216 (FIG. 2) with feed ports 116 (FIG. 1) and effluent discharges 220 (FIG. 2) with effluent discharges 127 (FIG. 1). Those are the only changes necessary to change a centrifuge from countercurrent operating mode 2A to cocurrent operating mode 1B. To convert a centrifuge from countercurrent operating mode 2A to cocurrent operating mode 1D, it is additionally necessary to change the direction of rotation of the conveyor and the bowl from counterclockwise (rotational arrows 212 and 218) to clockwise (rotational arrows 130 and 132) as viewed from the large end of the bowl, and to change the handedness of the conveyor to a left hand pitch.

To modify a centrifuge from cocurrent operating mode 2C to operate in countercurrent mode 1D, one replaces liquid feed ports 244 (FIG. 2) with feed ports 117 (FIG. 1) and effluent discharges 246 (FIG. 2) with effluent discharges 129 (FIG. 1). Those are the only changes necessary to change a centrifuge from countercurrent operating mode 2C to cocurrent operating mode 1D. To convert a centrifuge from countercurrent operating mode 2C to cocurrent operating mode 1B, it is additionally necessary to change the direction of rotation of the conveyor and the bowl from clockwise (rotational arrows 238 and 242) to counterclockwise (rotational arrows 126 and 128) as viewed from the large end of the bowl, and to change the handedness of the conveyor to a right hand pitch.

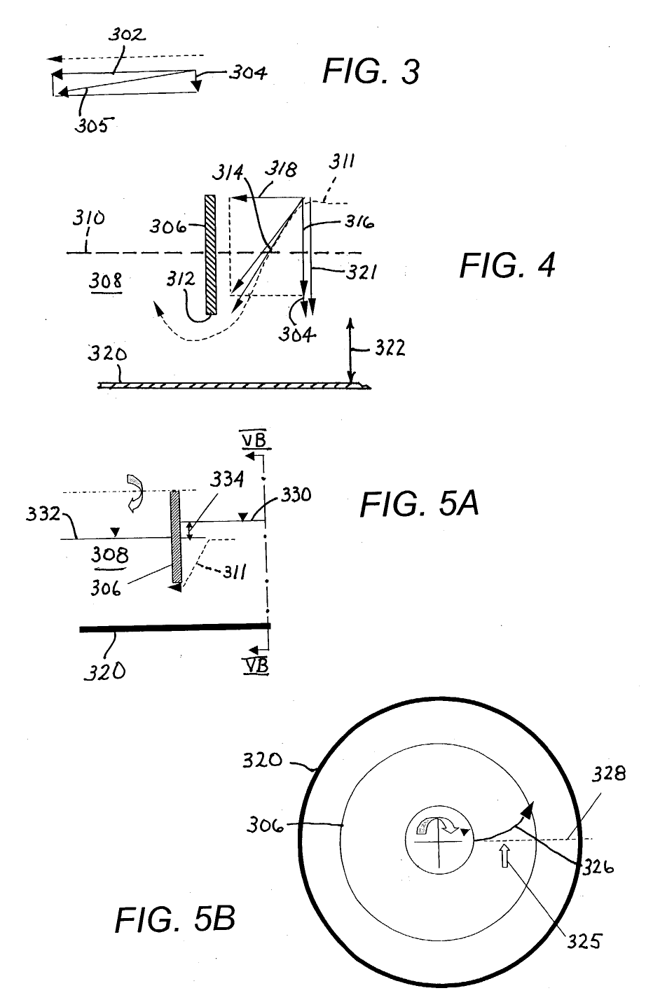

FIG. 3 shows vectors 302 and 304 representing the relative magnitudes of axial and radial velocity components, respectively, in a conventional ribbon-blade centrifuge. While the liquid flows axially (vector 302) along a cylindrical clarifier from a feed location to an exit at a large end of the machine, heavier solids settle out based on higher density difference compared with the liquid. Inasmuch as the radial settling velocity (vector 304) is usually small compared with the axial convective flow velocity (vector 302), the resultant velocity 305 is largely oriented along the axis of the machine. Given the large convective velocity 302, the retention time of solids is also small, resulting in poor settling and solids recovery by centrifugation.

As depicted in FIG. 4, an obstruction 306 extending radially into the clarifier pool 308 blocks the flow path at the pool surface 310, so as to force the flow 311 to the radially outer periphery 312 of the obstruction at a much larger radius. The resultant flow velocity 314 has a radially outward component 316 and a much reduced axial component 318. This radial component 316 is added to the settling velocity 304, increasing the speed with which the solids migrate toward a bowl wall 320, as indicated at 321. Also at the large radius the settling distance 322 to the bowl wall 320 is shorter and simultaneously the settling velocity is greater due to higher centrifugal gravity there, both effects increasing sedimentation and solids capture.

There is a problem associated with the design of FIG. 4. As illustrated in FIGS. 5A and 5B, as flow 311 moves radially outward in a rotating flow, a Coriolis force 325 tends to push the flow in a direction opposite to rotation (see fluid path arrow 326 in FIG. 5B). The fluid path 326 bends backward compared with the radial direction 328. In fact the tangential speed trails the local solid body rotation at the pool location with a larger radius. Due to the lower tangential speed, the flow has a lower G-force not attaining the expected higher G-force at the large radius of the periphery of obstruction 306. As the flow starts to develop a relative tangential velocity (opposite to the direction of rotation) along the flow path 326, the Coriolis force also tends to redirect the flow radially inward, inhibiting the flow from migrating to the outer diameter of the obstruction 306. Due to the flow resistance, the pool level builds up upstream of the obstruction 306, resulting in a liquid pool level 330 upstream of the obstruction that is higher than the liquid pool level 332 downstream of the obstruction, as shown in FIG. 5A. The difference 334 in pool level increases until the differential liquid head across the obstruction 306 is able to overcome the flow resistance to circumvent the blockage. The higher is the flow rate and the larger is the diameter of obstruction 306, the greater is this differential liquid head across the obstruction 306. There is a serious consequence to this as the elevated pool 330 upstream of the disk leads to a smaller dry beach or no dry beach in the conical section (not shown) of the decanter bowl 320 resulting in inadequate dewatering and drainage with wet cake.

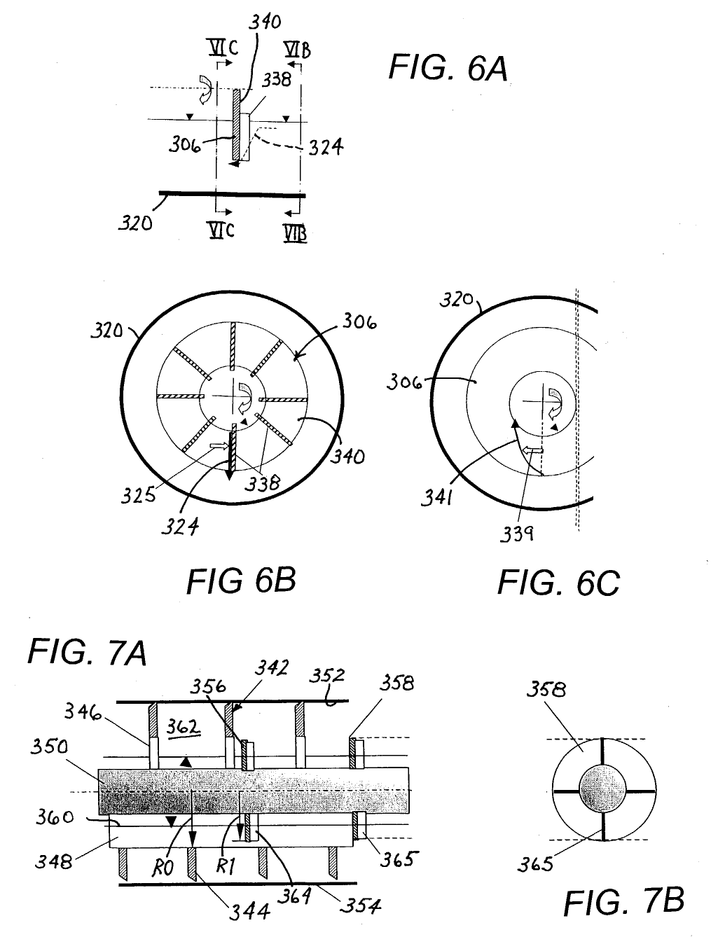

The above-discussed problem can be solved with an improved design diagrammatically illustrated in FIGS. 6A-6C. In order to reduce the flow resistance, vanes 338 with radial oriented surfaces are added to the upstream face 340 of the obstruction 306 irrespective of whether the obstruction takes the geometrical form of a disk (FIGS. 5B, 6B, 7A, 7B, 11A, 11B), a cone (FIGS., 8A, 8B) or a cylindrical hub (FIGS. 9A and 9B). As flow 324 moves to the large radius, the Coriolis force 325 is counteracted by the radial surface of the vanes 338 preventing the flow slipping backwards with respect to rotation. With the installation of vanes 338 on the upstream face 340 of the obstruction 306 there should be minimal to no liquid head buildup as illustrated in FIGS. 6A-6C where the obstruction 306 takes form of a disk with eight radial vanes 338 distributed around the circumference. Downstream of the obstruction 306, Coriolis force 339 is added that actually accelerates tangentially the flow 341 in the direction of rotation (therefore higher G) compared to the local solid body rotation of the pool as it moves radially inward toward the pool surface. FIG. 7A depicts a ribbon-type decanter centrifuge having a conveyor 342 with a ribbon blade 344 attached by posts 346 or axial vanes 348 to a hub 350 for pushing deposited cake solids (not shown) along an inner surface 352 of a centrifuge bowl 354. Plural liquid flow obstructions 356 and 358 in the form of annular disks are attached to hub 350 at spaced locations and extend through a liquid surface 360 into a clarifier pool 362. Disks 356 and 358 have a radial dimension or width R1 less than the inner or smaller radius of the ribbon blades R0. On their upstream faces, disks 356 and 358 are formed with a plurality of circumferentially equispaced radially extending vanes 364, 365 (FIG. 7B) as discussed above with reference to FIGS. 6A-6C.

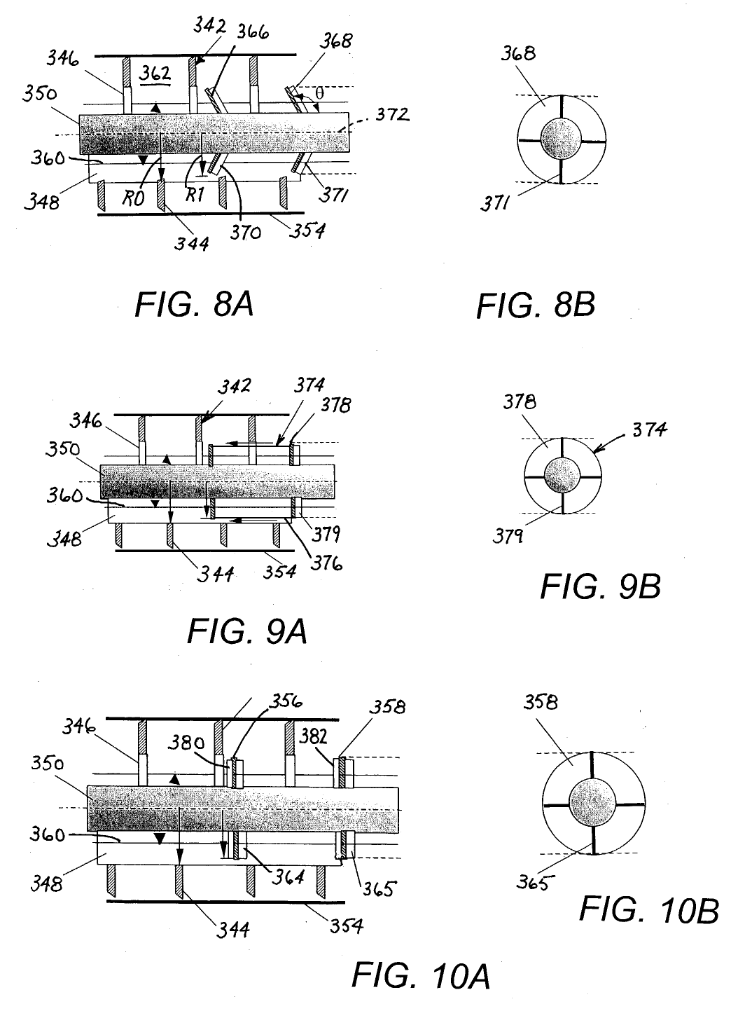

FIG. 8A depicts a ribbon-type decanter centrifuge similar to that shown in FIG. 7A. Instead of annular disks 356 and 358, however, the centrifuge of FIG. 8A is provided with liquid-flow obstructions 366 and 368 in the form of truncated cones that are attached to hub 350 at spaced locations and extend through liquid surface 360 into clarifier pool 362. Cones 366 and 368 have a radial dimension or width R1 less than or equal to the radial dimension or length of posts 346 or the radial dimension or width R0 of axial vanes 348. On their upstream faces, cones 366 and 368 are formed with a plurality of circumferentially equispaced and generally radially extending vanes 370, 371 (FIG. 8B) as discussed above with reference to FIGS. 6A-6C. Cones 366 and 368 have a defining angle θ in a range between 20 degrees and 160 degrees (disks 356 and 358 have an angle of 90 degrees relative to a machine axis 372).

When disks 356 and 358 or cones 366 and 368 are spaced closely to each other, the flow pattern simulates that of a conveyor hub extension 374 as shown in FIG. 9A. In some cases, a centrifuge may be provided with an actual conveyor hub extension 374 in the form of a cylinder 376 surrounding hub 350 and provided at least at an upstream side with an end face member such as an annular disk 378 or truncated cone (not separately illustrated in FIG. 9A) provided with a plurality of angularly equispaced radially extending vanes 379.

In most applications, the downstream faces of the disks 356 and 358, the cones 366 and 368, and extended hub 374 should not have vanes. If fluid rapidly moves back to the small radius close to the pool surface 360 from the periphery of the obstruction 356, 358, 366, 368, 374 at a larger radius, the angular momentum is conserved resulting in actually much higher centrifugal gravity compared to the local condition at the pool surface. This obviously increases separation. On the other hand, there are applications and reasons (such as power savings) in which it is advantageous to smoothly decelerate the flow as it flows back to the pool surface 360 at the smaller radius in which case radial vanes 380, 382 are installed on the downstream faces of disks 356, 358 (or cones 366, 368), as shown in FIG. 10A.

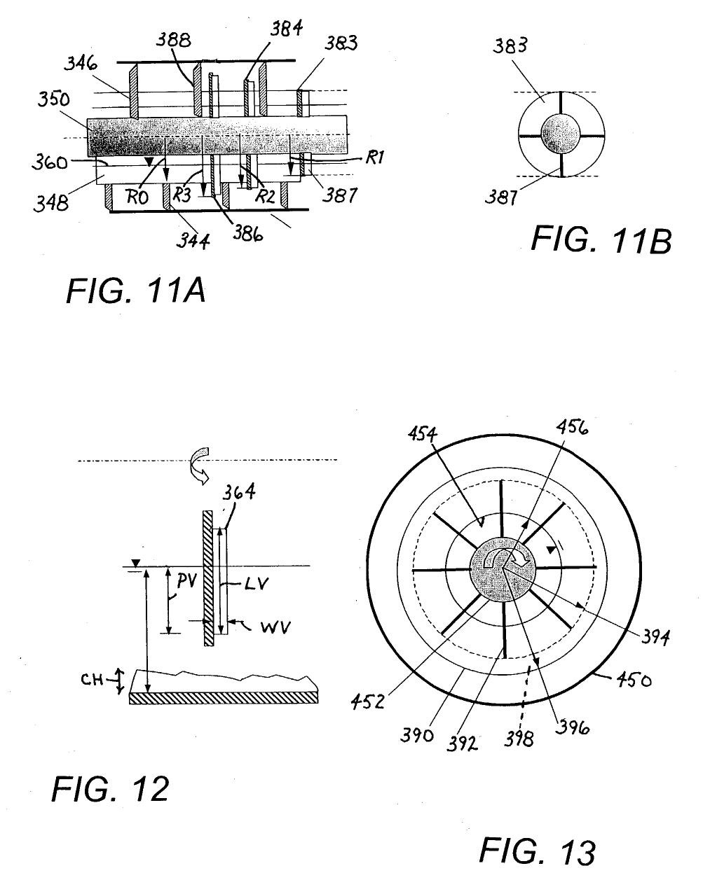

As depicted in FIG. 11A, flow obstructions 383, 384, and 386 exemplarily in the form of annular disks may have different radial dimensions R1, R2, and R3 with the latter two being greater than the radial dimension R0 corresponding to the smaller or inner radius of the ribbon blades 344. The axial flow is interrupted as it is forced to go to a larger pool diameter circumventing disks 384 and 386. In other applications, obstruction radius R1 can be smaller than the inner radius R0 of the ribbon blade 344 to allow an uninterrupted axial fluid flow passage along the clarifier (FIGS. 7A, 8A, 9A, 10A). Disks 383, 384, 386 are provided on their upstream faces with sets of angularly equispaced radially extending vanes 387 (only one set labeled for purposes of clarity.

The geometry of vanes 364, 365, 370, 371, and 379 (see FIG. 12) such as their shape, length LV, width WV, penetration into the pool PV, number, and thus the total surface area are optimized to get the best separation. Also the cake height CH locally needs to be factored into consideration. In FIG. 11A the top half of the schematic shows the installation for a solid conveyor blade 388 while the lower half show the installation of ribbon blade 344.

The vanes 364, 365, 370, 371, and 379 on the upstream faces of disks 356 and 358, cones 366 and 368 and hub 374 accomplish their proper function in terms of counteracting the Coriolis force as fluid flows to a large radius. However, there is a disadvantage in that a radial jet may establish adjacent to the driving face of the vanes 364, 365, 370, 371, and 379, which after leaving the vanes and disks 356 and 358, cones 366 and 368 and hub 374 plunges into the pool with significant radial momentum. This radial jet causes turbulence and disturbance on the already settled solids. There are two ways in which this problem can be alleviated. As depicted in FIG. 13, a liquid-flow obstruction 390 as described herein may be provided with radially directed vanes 392 having a radial dimension 394 falling short of the radial dimension 396 of the obstruction 390. This creates a clear area 398 along the periphery of the obstruction 390 where the radial velocity will slow down and where any concentrated jets leaving the driving face of the vanes 392 can be spread out over the clear area 398 of the surface of obstruction 390. FIG. 13 also depicts a centrifuge bowl 450, a conveyor hub 452, a pool surface 454 and a pool radius 456.

As depicted in FIG. 14, a liquid-flow obstruction 400 is provided with a plurality of circumferentially spaced vanes 402 that are forwardly curved with respect to machine rotation so that the momentum along the driving face in the radial direction is reduced. The momentum is passed to the tangential direction. When the curved vanes 402 end at a radius 404 less than the radius 406 of the obstruction 400, a clear portion 408 of the obstruction 400 further allows spreading of the flow across the entire circumference of the obstruction 400. These two provisions further enhance the function of the liquid-flow obstruction 400 in bringing the flow to a larger radius with higher G, facilitating a shorter distance for heavier phase (solids) to settle to the bowl wall, and increasing the radial settling speed with the radial component of the main flow as shown in FIG. 4, reducing flow resistance with the vanes 402 on the upstream face of the obstruction 400 yet reducing also the negative impact from possible strong radial momentum from jets adjacent to the vanes. FIG. 14 also depicts a centrifuge bowl 458, a conveyor hub 460, a pool surface 462 and a pool radius 464.

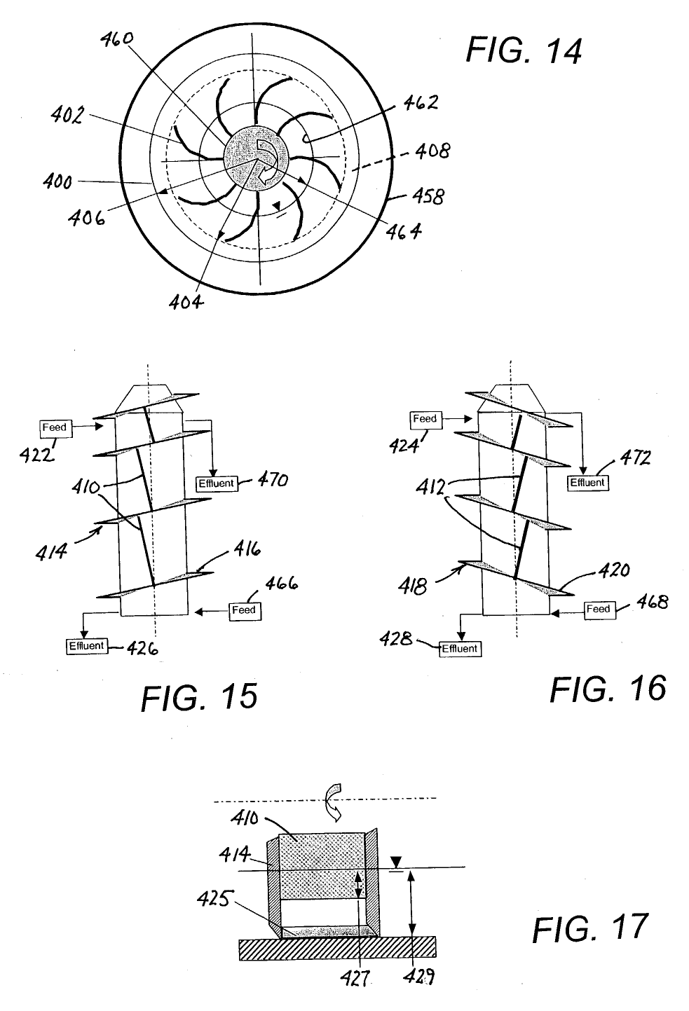

Disks with upstream vanes can be installed for solid blade conveyors as well as for ribbon-blade conveyors. Accordingly, as illustrated in FIGS. 15 and 16, discrete baffles or plates 410 and 412 that dip into the clarifier pool are provided for a right-hand-pitch conveyor 414 having a solid blade or blades 416 and a left-hand-pitch conveyor 418 having a solid blade or blades 420, along different locations in the clarifier between the feed point 422, 424 to the effluent exit 426, 428 in a countercurrent design or between feed point, 466, 468 and effluent point 470, 472 in a cocurrent design. A cross section of a representative baffle 410 or 412 is shown in FIG. 17. The penetration 427 of the baffle 410 into the pool 429 depends on the flow rate, the height of the cake 425, and the location of the baffle. Baffle 410 as shown in FIG. 17 can be adjustable using a mechanism so that the optimal penetration is obtained for a given application and process condition.

When converting from an existing design to an improved design for a solid-blade conveyor as discussed above with reference to FIGS. 1 and 2, it is beneficial to have baffles 410, 412 as shown in FIG. 17 and FIG. 15 or 16, as the case may be, installed near the feed zone within a few warps (pitches or leads) of the feed introduction so that flow is properly accelerated as it is introduced into the separation pool.

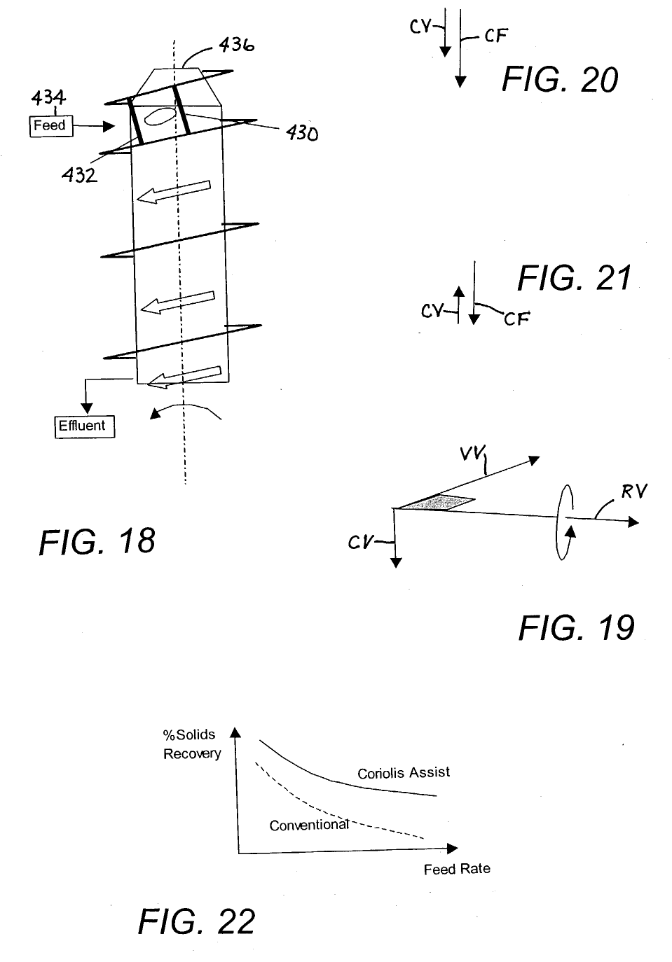

As illustrated in FIG. 18, two baffles 430 and 432 are used in the feed zone 434 for different purposes: The baffle 430 facing the cake discharge small-diameter end 436 is to stop flow slipping to the conical beach 438 when the direction of rotation is reversed and the second baffle 432 facing the large diameter end 440 of the machine redirects the flow to a greater diameter with higher G. Given the different functions of these two baffles, the extent of their penetration into the pool, PV or 427, may be different.

Baffles 410, 412, 430, 432 may be used regardless of whether a machine is operating in a Coriolis resist (CR) mode, a Coriolis neutral mode or a Coriolis assist (CA) mode. Tests of these demonstrate superior performance compared with configuration running with CR and CA mode without baffles. The best separations performance is achieved by a centrifuge operating in a Coriolis assist mode and provided with baffles 410 or 412, and 430 and 432. The next best performance is achieved by a machine operating in a Coriolis assist mode, without such baffles. The next best performance is attained in a centrifuge operating in a Coriolis neutral mode with disks and vanes on upstream face. A centrifuge operating in a Coriolis neutral mode without separation-improving modifications as discussed herein has a better separation performance than a machine operating in a Coriolis resist mode, irrespective of whether the latter machine is provided with baffles 410, 412, 430, 432.

The efficacy of the above-described methods for improving separation performance is due in large part to the proper accounting for Coriolis forces. In the rotating frame of a centrifuge when fluid flows with a high velocity relative to the rotating centrifuge, a Coriolis force vector CF is induced with a direction pointing perpendicular to the plane formed by the rotation vector RV (using right hand rule) and the velocity vector VV as shown in FIG. 19. The magnitude of the Coriolis force CV is directly proportional to the magnitude of the velocity vector VV and the rotation speed RV.

In most conventional centrifuge operating modes, depending on the design and flow pattern, the Coriolis force vector CV points in a direction radially inward opposing the centrifugal force vector CF (see FIG. 21) which always points radially outward toward the bowl. Under such circumstance, the effect from the centrifugal force CF is discounted resulting in poorer performance. When the design and/or operation are modified such that the Coriolis force CV points radially outward toward the bowl wall as shown in FIG. 20 this is added to the centrifugal force in make more efficient separation. The Coriolis assist provides much improved separation as evident in FIG. 22 where the solids recovery is charted against feed rate comparing the conventional with the Coriolis assist design. At low flow rate, the velocity vector is small and there is little effect. However at high flow rate and thus high velocity the Coriolis force adds to the centrifugal force to improve separation and higher solids recovery is realized for the same feed rate. Also for high-speed high-gravity centrifuge the rotational vector also increases and there is a significant increase in process benefit with the Coriolis assist design.

When the flow vector is in parallel with the rotation vector such as in axial-flow ribbon designs, other novel means are introduced herein whereby Coriolis force is also utilized to improve the design so as to achieve process improvement.

The following provides further explanation of the action or effect of Coriolis forces in the various centrifuge operating modes of FIGS. 1 and 2.

The Coriolis force vector CV is given by a vector product of the relative (in the frame of rotation) flow velocity VV and the rotation vector RV as schematically represented by FIG. 19. In conventional operating modes such as countercurrent operating mode 1A for right hand pitch and countercurrent operating mode 1C for left hand pitch, based on the vector product scheme as discussed above, the Coriolis force vector is directed radially inward toward the axis opposing the centrifugal force vector CF (see FIG. 21). This operating condition is referred to as “Coriolis Resist” (CR). The Coriolis force undermines the centrifugal force in effectuating separation of the heavier solids from the liquid. This condition is especially serious for high-speed/high-G centrifuges and for high-flow-rate machines because the magnitude of the Coriolis force is proportional to both the rotation speed as well as the flow velocity, which in turn is related to the flow rate. On the other hand, it would be advantageous to design and operate the machine such that the Coriolis force vector CV is in alignment with the centrifugal force vector CF as shown in FIG. 20 so that both point radially outward toward the bowl wall, resulting in enhanced separation from the combined forces. This condition is referred to as “Coriolis Assist” (CA). Operating mode 1B for the right hand pitch and operating mode 1D for the left hand pitch are examples of Coriolis Assist modes in countercurrent flow designs. When the feed is introduced at the middle of the clarifier as in operating mode 1E for right hand pitch and operating mode 1F for left hand pitch, the liquid flow runs back toward the conical beach and is subject to CR along this flow path prior to the flow turning around to flow toward the effluent discharge in CA mode. Testing has confirmed that the effective clarifier or clarification section is significantly reduced in operating modes 1E and 1F; therefore it is desirable to eliminate any portions of the flow path that is in CR mode. This is accomplished by modifying operating modes 1E and 1F to operating modes 1B and 1D. In some applications it may be desirable to introduce the feed even further up the conical beach (not shown) in countercurrent flow designs in order to maximize the distance and time of CA application.

In conventional cocurrent operating modes such as operating mode 2A for right hand pitch and 2C for left hand pitch, based on the vector product scheme as discussed above, the Coriolis force vector CV is directed radially inward toward the axis opposing the centrifugal force vector CF (see FIG. 21). These operating modes 2A and 2C exhibit reduced separation performance which is due to CR action. The Coriolis force CV undermines the action of centrifugal force in separating the heavier solids from the liquid. On the other hand, in cocurrent operating mode 2B for right hand pitch and 2D for left hand pitch, the Coriolis vector CV is in alignment with the centrifugal force vector CF as shown in FIG. 20 so that both pointed radially outward toward the bowl wall resulting in enhanced separation from the combined forces. When the feed is introduced at the middle of the clarifier as in cocurrent operating mode 2E for right hand pitch and 2F for left hand pitch, the liquid flow runs back toward the conical beach and is subject to CR along this flow path prior to the flow turning around to flow toward the effluent discharge even though the latter flow path is in CA mode. Accordingly, it is desirable to eliminate any portion of the flow path that is in CR mode and to further modify change the operating modes 2E and 2F to that operating modes 2B and 2D to maximize the CA effect.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for improving separation performance of a decanter-type centrifuge wherein liquid flow is in a first direction and solids transport is in a second direction, rotation of the centrifuge generating a radially outward centrifugal force inducing sedimentation of solids out of the liquid flow, the method comprising:
inspecting said centrifuge to determine whether said centrifuge is operating in a Coriolis-resist or a Coriolis-neutral mode; and
upon determining that said centrifuge is operating in a Coriolis-resist or Coriolis-neutral mode, modifying said centrifuge to operate in a Coriolis-assist mode.

2. The method defined in claim 1 wherein said centrifuge includes a bowl and a conveyor with a differential rotation relative to one another, said conveyor having a conveyor flight pitch with a given handedness, said bowl having a selected liquid feed location, the modifying of the centrifuge including actions taken from the group consisting of:
changing the direction of rotation of said conveyor and said bowl;
changing the differential rotation of said bowl and said conveyor;
changing the handedness of the conveyor flight pitch; and
changing the location of said liquid feed.

3. The method defined in claim 2 wherein the modified centrifuge has an operating mode taken from the group consisting of:
Mode I: conveyor with right hand pitch, liquid flow and solids transport countercurrent to one another, conveyor and bowl rotating counterclockwise as viewed from large end of bowl, conveyor rotating faster than bowl;
Mode II: conveyor with left hand pitch, liquid flow and solids transport countercurrent to one another, conveyor and bowl rotating clockwise as viewed from large end of bowl, conveyor rotating faster than bowl;
Mode III: conveyor with right hand pitch, liquid flow and solids transport cocurrent with one another, conveyor and bowl rotating clockwise as viewed from large end of bowl, bowl rotating faster than conveyor; and
Mode IV: conveyor with left hand pitch, liquid flow and solids transport cocurrent with one another, conveyor and bowl rotating counterclockwise as viewed from large end of bowl, bowl rotating faster than conveyor.

4. The method defined in claim 3 wherein the inspecting of said centrifuge reveals that said conveyor has a right hand pitch, said centrifuge has a liquid feed at a junction between a beach section of said bowl and a clarifier pool section of said bowl, said centrifuge has an effluent discharge at a large end of said bowl, opposite said beach section, so that liquid flow and solids transport are countercurrent to one another, and said bowl and said conveyor rotate in a clockwise direction as viewed from the large end of said bowl, with said bowl rotating faster than said conveyor, the modifying of said centrifuge including changing the direction of rotation of said conveyor and said bowl from clockwise to counterclockwise as viewed from the large end of said bowl.

5. The method defined in claim 4 wherein the modifying of said centrifuge further includes changing the differential rotation of said bowl and said conveyor so that said conveyor rotates faster than said bowl.

6. The method defined in claim 3 wherein the inspecting of said centrifuge reveals that said conveyor has a left hand pitch, said centrifuge has a liquid feed at a junction between a beach section of said bowl and a clarifier pool section of said bowl, said centrifuge has an effluent discharge at a large end of said bowl, opposite said beach section, so that liquid flow and solids transport are countercurrent to one another, and said bowl and said conveyor rotate in a counterclockwise direction as viewed from the large end of said bowl, with said bowl rotating faster than said conveyor, the modifying of said centrifuge including changing the direction of rotation of said conveyor and said bowl from counterclockwise to clockwise as viewed from the large end of said bowl.

7. The method defined in claim 6 wherein the modifying of said centrifuge further includes changing the differential rotation of said bowl and said conveyor so that said conveyor rotates faster than said bowl.

8. The method defined in claim 3 wherein the inspecting of said centrifuge reveals that said conveyor has a right hand pitch, said centrifuge has a liquid feed at a junction between a beach section of said bowl and a clarifier pool section of said bowl, said centrifuge has an effluent discharge at a large end of said bowl, opposite said beach section, so that liquid flow and solids transport are countercurrent to one another, and said bowl and said conveyor rotate in a clockwise direction as viewed from the large end of said bowl, with said bowl rotating faster than said conveyor, the modifying of said centrifuge including changing said conveyor to have a left-hand pitch.

9. The method defined in claim 8 wherein the modifying of said centrifuge further includes changing the differential rotation of said bowl and said conveyor so that said conveyor rotates faster than said bowl.

10. The method defined in claim 3 wherein the inspecting of said centrifuge reveals that said conveyor has a left hand pitch, said centrifuge has a liquid feed at a junction between a beach section of said bowl and a clarifier pool section of said bowl, said centrifuge has an effluent discharge at a large end of said bowl, opposite said beach section, so that liquid flow and solids transport are countercurrent to one another, and said bowl and said conveyor rotate in a counterclockwise direction as viewed from the large end of said bowl, with said bowl rotating faster than said conveyor, the modifying of said centrifuge including changing said conveyor to have a right hand pitch.

11. The method defined in claim 10 wherein the modifying of said centrifuge further includes changing the differential rotation of said bowl and said conveyor so that said conveyor rotates faster than said bowl.

12. The method defined in claim 3 wherein the inspecting of said centrifuge reveals that said centrifuge has a liquid feed within a middle range of a clarifier pool section of said bowl and that said centrifuge has an effluent discharge at a large end of said bowl, opposite a beach section, so that liquid flow and solids transport are countercurrent to one another, the modifying of said centrifuge including relocating the feed in proximity to the junction.

13. The method defined in claim 12 wherein the inspecting of said centrifuge additionally reveals that said conveyor has a right hand pitch and that said bowl and said conveyor rotate in a counterclockwise direction as viewed from the large end of said bowl, with said conveyor rotating faster than said bowl, the modifying of said centrifuge additionally including changing the direction of rotation of said conveyor and said bowl from counterclockwise to clockwise as viewed from the large end of said bowl and changing said conveyor to have a left hand pitch.

14. The method defined in claim 12 wherein the inspecting of said centrifuge further reveals that said conveyor has a left hand pitch and that said bowl and said conveyor rotate in a clockwise direction as viewed from the large end of said bowl, with said conveyor rotating faster than said bowl, the modifying of said centrifuge further including changing the direction of rotation of said conveyor and said bowl from clockwise to counterclockwise as viewed from the large end of said bowl and changing said conveyor to have a right hand pitch.

15. The method defined in claim 3 wherein the inspecting of said centrifuge reveals that said conveyor has a right hand pitch, said centrifuge has an effluent discharge at a junction between a beach section of said bowl and a clarifier pool section of said bowl, said centrifuge has a liquid feed at a large end of said bowl, opposite said beach section, so that liquid flow and solids transport are cocurrent to one another, and said bowl and said conveyor rotate in a counterclockwise direction as viewed from the large end of said bowl, with said conveyor rotating faster than said bowl, the modifying of said centrifuge including changing the direction of rotation of said conveyor and said bowl from counterclockwise to clockwise as viewed from the large end of said bowl.

16. The method defined in claim 15 wherein the modifying of said centrifuge further includes changing the differential rotation of said bowl and said conveyor so that said bowl rotates faster than said conveyor.

17. The method defined in claim 3 wherein the inspecting of said centrifuge reveals that said conveyor has a left hand pitch, said centrifuge has an effluent discharge at a junction between a beach section of said bowl and a clarifier pool section of said bowl, said centrifuge has a liquid feed at a large end of said bowl, opposite said beach section, so that liquid flow and solids transport are cocurrent to one another, and said bowl and said conveyor rotate in a clockwise direction as viewed from the large end of said bowl, with said conveyor rotating faster than said bowl, the modifying of said centrifuge including changing the direction of rotation of said conveyor and said bowl from clockwise to counterclockwise as viewed from the large end of said bowl.

18. The method defined in claim 17 wherein the modifying of said centrifuge further includes changing the differential rotation of said bowl and said conveyor so that said bowl rotates faster than said conveyor.

19. The method defined in claim 3 wherein the inspecting of said centrifuge reveals that said conveyor has a right hand pitch, said centrifuge has an effluent discharge at a junction between a beach section of said bowl and a clarifier pool section of said bowl, said centrifuge has a liquid feed at a large end of said bowl, opposite said beach section, so that liquid flow and solids transport are cocurrent to one another, and said bowl and said conveyor rotate in a counterclockwise direction as viewed from the large end of said bowl, with said conveyor rotating faster than said bowl, the modifying of said centrifuge including changing said conveyor to have a left hand pitch.

20. The method defined in claim 19 wherein the modifying of said centrifuge further includes changing the differential rotation of said bowl and said conveyor so that said bowl rotates faster than said conveyor.

21. The method defined in claim 3 wherein the inspecting of said centrifuge reveals that said conveyor has a left hand pitch, said centrifuge has an effluent discharge at a junction between a beach section of said bowl and a clarifier pool section of said bowl, said centrifuge has a liquid feed at a large end of said bowl, opposite said beach section, so that liquid flow and solids transport are cocurrent to one another, and said bowl and said conveyor rotate in a clockwise direction as viewed from the large end of said bowl, with said conveyor rotating faster than said bowl, the modifying of said centrifuge including changing said conveyor to have a right hand pitch.

22. The method defined in claim 21 wherein the modifying of said centrifuge further includes changing the differential rotation of said bowl and said conveyor so that said bowl rotates faster than said conveyor.

23. The method defined in claim 3 wherein the inspecting of said centrifuge reveals that said centrifuge has a liquid feed within a middle range of a clarifier pool section of said bowl and that said centrifuge has an effluent discharge at a junction between a beach section of said bowl and a clarifer pool section of said bowl, so that liquid flow and solids transport are cocurrent to one another, the modifying of said centrifuge including relocating the feed to a large end of said bowl, opposite said beach section.

24. The method defined in claim 23 wherein the inspecting of said centrifuge additionally reveals that said conveyor has a right hand pitch and that said bowl and said conveyor rotate in a clockwise direction as viewed from the large end of said bowl, with said bowl rotating faster than said bowl, the modifying of said centrifuge additionally including changing the direction of rotation of said conveyor and said bowl from clockwise to counterclockwise as viewed from the large end of said bowl and changing said conveyor to have a left hand pitch.

25. The method defined in claim 23 wherein the inspecting of said centrifuge further reveals that said conveyor has a left hand pitch and that said bowl and said conveyor rotate in a counterclockwise direction as viewed from the large end of said bowl, with said bowl rotating faster than said conveyor, the modifying of said centrifuge further including changing the direction of rotation of said conveyor and said bowl from counterclockwise to clockwise as viewed from the large end of said bowl and changing said conveyor to have a right hand pitch.

26. The method defined in claim 3 wherein said centrifuge has an effluent discharge location and a flow pattern taken from the group of countercurrent flow in which liquid flow and cake solids transport are in substantially opposite directions and cocurrent flow in which liquid flow and cake solids flow are substantially in the same direction, the modifying of said centrifuge further including changing said effluent discharge location together with said liquid feed location, thereby altering the flow pattern in said centrifuge from one of said countercurrent flow and said cocurrent flow to the other of said countercurrent flow and said cocurrent flow.

27. The method defined in claim 26 wherein the inspecting of said centrifuge reveals that said conveyor has a right hand pitch, said centrifuge has a liquid feed located at a junction between a beach section of said bowl and a clarifier pool section of said bowl, said centrifuge has an effluent discharge located at a large end of said bowl, opposite said beach section, so that liquid flow and solids transport are countercurrent to one another, and said bowl and said conveyor rotate in a clockwise direction as viewed from the large end of said bowl, with said bowl rotating faster than said conveyor, the modifying of said centrifuge including changing the location of said liquid feed to said large end of said bowl and changing the location of said effluent discharge to said junction.

28. The method defined in claim 27 wherein the modifying of said centrifuge further includes changing the direction of rotation of said conveyor and said bowl from clockwise to counterclockwise as viewed from the large end of said bowl, and changing the handedness of said conveyor to a left hand pitch.

29. The method defined in claim 26 wherein the inspecting of said centrifuge reveals that said conveyor has a left hand pitch, said centrifuge has a liquid feed at a junction between a beach section of said bowl and a clarifier pool section of said bowl, said centrifuge has an effluent discharge at a large end of said bowl, opposite said beach section, so that liquid flow and solids transport are countercurrent to one another, and said bowl and said conveyor rotate in a counterclockwise direction as viewed from the large end of said bowl, with said bowl rotating faster than said conveyor, the modifying of said centrifuge including changing the location of said liquid feed to said large end of said bowl and changing the location of said effluent discharge to said junction.

30. The method defined in claim 29 wherein the modifying of said centrifuge further includes changing the direction of rotation of said conveyor and said bowl from counter clockwise to clockwise as viewed from the large end of said bowl, and changing the handedness of said conveyor to a right hand pitch.

31. The method defined in claim 26 wherein the inspecting of said centrifuge reveals that said conveyor has a right hand pitch, said centrifuge has an effluent discharge located at a junction between a beach section of said bowl and a clarifier pool section of said bowl, said centrifuge has a liquid feed located at a large end of said bowl, opposite said beach section, so that liquid flow and solids transport are cocurrent to one another, and said bowl and said conveyor rotate in a counterclockwise direction as viewed from the large end of said bowl, with said conveyor rotating faster than said bowl, the modifying of said centrifuge including changing the location of said liquid feed to said junction and changing the location of said effluent discharge to said large end of said bowl.

32. The method defined in claim 31 wherein the modifying of said centrifuge further includes changing the direction of rotation of said conveyor and said bowl from counterclockwise to clockwise as viewed from the large end of said bowl, and changing the handedness of said conveyor to a left hand pitch.

33. The method defined in claim 26 wherein the inspecting of said centrifuge reveals that said conveyor has a left hand pitch, said centrifuge has an effluent discharge at a junction between a beach section of said bowl and a clarifier pool section of said bowl, said centrifuge has a liquid feed at a large end of said bowl, opposite said beach section, so that liquid flow and solids transport are cocurrent to one another, and said bowl and said conveyor rotate in a clockwise direction as viewed from the large end of said bowl, with said conveyor rotating faster than said bowl, the modifying of said centrifuge including changing the location of said liquid feed to said junction and changing the location of said effluent discharge to said large end of said bowl.

34. The method defined in claim 33 wherein the modifying of said centrifuge further includes changing the direction of rotation of said conveyor and said bowl from clockwise to counterclockwise as viewed from the large end of said bowl, and changing the handedness of said conveyor to a right hand pitch.

35. The method defined in claim 1, further comprising attaching to said conveyor, between adjacent flights thereof, at least one baffle extending across a path of liquid flow from a liquid feed to an effluent discharge.

36. The method defined in claim 35 wherein said baffle extends from a hub of said conveyor partially into a clarifier pool.

37. The method defined in claim 36 wherein said baffle is one of a plurality of baffles extending from said hub of said conveyor partially into said clarifier pool and across said path of liquid flow from said liquid feed to said effluent discharge.

38. The method defined in claim 35 wherein said baffle is a first baffle, further comprising attaching to said conveyor, between adjacent flights thereof, a second baffle dipping into the separation pool at a location between a liquid feed port and cake discharge of said centrifuge.

39. The method defined in claim 35 wherein said baffle is disposed proximately to said liquid feed.

40. A method for improving separation performance of a decanter centrifuge having bowl and a conveyor and a liquid feed in a middle range of a clarifier pool section of said bowl, said centrifuge being provided with an effluent discharge near one end of said bowl, the method comprising relocating said liquid feed to an end of said bowl opposite said effluent discharge.

41. The method defined in claim 40 wherein said effluent discharge is located at a large end of said bowl, opposite a beach section of said bowl, said liquid feed being relocated to a region about a junction of said beach section and a claifier-pool section of said bowl.

42. The method defined in claim 41 wherein said liquid feed is relocated to a position up said beach section to maximize clarifier length.

43. A decanter-type centrifuge comprising:
a bowl having a clarifier pool section and a conical beach section;
a liquid feed at a junction of said clarifier pool section and said beach section;
an effluent discharge at a large end of said bowl, opposite said beach section;
a conveyor having a right hand pitch; and
a rotary drive assembly operatively connected to said conveyor and said bowl for rotating said conveyor and said bowl in a counterclockwise direction as viewed from said large end of said bowl, with said conveyor rotating faster than said bowl.

44. A decanter-type centrifuge comprising:
a bowl having a clarifier pool section and a conical beach section;
an effluent discharge at a junction of said clarifier pool section and said beach section;
a liquid feed at a large end of said bowl, opposite said beach section;
a conveyor having a left hand pitch; and
a rotary drive assembly operatively connected to said conveyor and said bowl for rotating said conveyor and said bowl in a counterclockwise direction as viewed from said large end of said bowl, with said bowl rotating faster than said conveyor.

45. A decanter centrifuge comprising:
a bowl having a clarifier pool section and a conical beach section;
an effluent discharge on said bowl;
a liquid feed on said bowl;
a conveyor disposed inside said bowl for differential rotation therewith; and
at least one baffle attached to said conveyor between adjacent flights thereof and extending across a path of liquid flow from said liquid feed to said effluent discharge.

46. The centrifuge defined in claim 45 wherein said baffle extends from a hub of said conveyor partially into a clarifier pool.

47. The centrifuge defined in claim 46 wherein said baffle is one of a plurality of baffles extending from said hub of said conveyor partially into said clarifier pool and across said path of liquid flow from said liquid feed to said effluent discharge.

48. The centrifuge defined in claim 45 wherein said baffle is a first baffle, further comprising a second baffle attached to said conveyor, between adjacent flights thereof, a second baffle extending between feed ports and the cake discharge.

49. The centrifuge defined in claim 45 wherein said first baffle and said second baffle are attached to said conveyor proximately to said liquid feed.

50. The centrifuge defined in claim 45 wherein said baffle is disposed proximately to said liquid feed.

51. A centrifuge comprising:
a bowl;
a ribbon conveyor disposed in said bowl; and
at least one flow guide member extending from the central structure support of said conveyor into a clarifier pool in said bowl for redirecting liquid flow in said clarifier pool in an at least partially radially outward direction.

52. The centrifuge defined in claim 51 wherein said flow guide member is provided on an upstream side with at least one vane extending into said clarifier pool.

53. The centrifuge defined in claim 52 wherein said vane extends in a generally radial direction.

54. The centrifuge defined in claim 53 wherein said flow guide member has a first outer edge and said vane has a second outer edge, said second outer edge being disposed at a radial distance from an axis of said bowl less than a radial distance of said first outer edge from said axis.

55. The centrifuge defined in claim 54 wherein an outer end portion of said vane is directed at least partially in a rotation forward direction.

56. The centrifuge defined in claim 52 wherein said vane is one of a plurality of vanes spaced from one another in a circumferential direction of said guide member and extending in a generally radial direction into said clarifier pool.

57. The centrifuge defined in claim 52 wherein said flow guide member is provided on an upstream side with at least one vane extending in a generally radial direction into said clarifier pool.

58. The centrifuge defined in claim 51 wherein said flow guide member is taken from the group consisting of an annular disc, a truncated cone, and a cylinder with a centrally perforated end plate on an upstream side.

59. The centrifuge defined in claim 58 wherein said flow guide member is provided on an upstream side with a plurality of vanes extending in a generally radial direction into said clarifier pool.

60. The centrifuge defined in claim 51 wherein said flow guide member is located in proximity to a feed zone.
